(19) United States
(12) Patent Application Publication
(10) Pub. No.: US 2024/0227333 A9
(43) Pub. Date: Jul. 11, 2024

(54) INJECTION MOULDING OF OPTICAL COMPONENTS

(71) Applicants: IQS GROUP s.r.o., Husinec-Rez (CZ); TREVOS a.s., Turnov (CZ)

(72) Inventors: Marek Skeren, Nova Ves I (CZ); Zbynek Ryzi, Littleton, MA (US); Petr Lobaz, Plzen (CZ); Michal Opocensky, Turnov (CZ); Jaroslav Pilar, Slana (CZ); Roman Grund, Orech (CZ)

(21) Appl. No.: 18/546,118

(22) PCT Filed: Feb. 9, 2022
(86) PCT No.: PCT/EP2022/053107

§ 371 Date: Aug. 11, 2023

(30) Foreign Application Priority Data
Feb. 11, 2021 (GB) 2101921.1

(51) Int. Cl. B29D 11/00; B29C 45/14; B29C 45/78

(52) U.S. Cl. CPC B29D 11/0073; B29C 45/14778; B29C 45/14827; B29C 45/78; B29C 2045/14877

(57) ABSTRACT

A method for injection moulding an optical component (20), e.g. a cover for a luminaire, with an incorporated optical function, the component (20) comprising an injection moulded body (18) and at least one optically functional relief structure (4) applied thereto, the relief structure (4) forming or contributing to the optical function of the component (20) to be moulded, wherein the method comprises: (i) providing an insert (2) comprising the said optical structure (4) in the form of an open-face relief structure (4) provided on a face, surface or portion of the insert (2), (ii) mounting the insert (2) inside a mould cavity (11) in which the component (20) is to be moulded, with the open-face relief structure (4) facing and at least partially abutting a surface portion of the mould cavity (11), and (iii) rear-injection moulding a body (18) of the component (20) within the mould cavity (11) so as to incorporate the insert (2) in the component body (18), wherein the said method is carried out with parameters selected and/or controlled such that during the injection moulding step (iii) the temperature at or on the face, surface or portion of the insert (2) provided with the relief structure (4) remains below the lowest of the glass transition temperature, melting temperature and temperature of onset of thermal decomposition of the material of that face, surface or portion of the insert (2).

### TECHNICAL FIELD

This invention relates to injection moulding of optical components. More particularly, though not exclusively, the invention relates to methods and apparatuses for the production of optical components by an injection moulding technique, especially an injection moulding technique which facilitates the production of optical components which incorporate embedded optical structures, such as those destined for use in lighting applications.

### BACKGROUND OF THE INVENTION AND PRIOR ART

For a long time injection moulding processes have been employed for the production of a vast variety of plastic products of a wide variety of shapes and sizes in a wide range of industries. In the lighting sector in particular, among such products are optical components such as prisms, lenses, Fresnel lenses of various types, and other micro-optical or micro-structured optical components, such as micro-lens arrays, diffusers, beam splitters, light distribution elements, as well as others. Injection moulding as a process is an attractive approach for the production of such components, owing to its ability to produce such components in high volumes and at low cost per part. However, injection moulding does have some drawbacks. One of the most significant ones is the high cost of tooling, i.e. the design and manufacture of the mould, especially in cases where the shape of the moulded part is complex or it needs to be produced with narrow tolerances.

Over the years many injection moulding techniques have been developed whose aim has been to make the injection moulding process more flexible. For example, when a series of product variations which differ only in small details need to be produced effectively, one generic mould can be produced for all of them, and only certain parts of the mould need to be changed or replaced or modified in order to produce each different product variant.

Other examples include so-called IML (in-mould labelling) and IMD (in-mould decorating) techniques, which use pre-produced inserts—typically with a pre-printed motif or pattern, e.g. a decorative pattern or a label—which are then inserted into the form and combined (i.e. merged) with the part being injection moulded in the same mould. These techniques are widely used for adding various surface properties (e.g. graphic, decorative) to the surface of an injection moulded part.

In the field of injection moulded plastic optical components, it is commonplace to employ various inserts placed inside the mould to produce optical elements with injection moulded optics, in particular micro-textured or micro-structured optical elements. In some cases such inserts can actually form part of the mould, in which case they are usually made from metal (e.g. by micro-machining, diamond engraving, laser texturing or electroforming), whereas in other cases they can be pre-produced in the form of a plastic substrate with a surface finish (i.e. a surface optical structure) applied thereto, which is rear injected in the mould together with the injection moulding of the plastic part or body itself. In the latter case the insert becomes integrally bonded to the plastic part or body, thereby imparting its optical properties to the resulting moulded part or body. Compared with metal inserts which form part of the mould, such plastic textured inserts need to be placed into the mould repeatedly with the moulding of each part or body.

The latter approach above—namely, in-mould injecting using a pre-structured insert—is especially advantageous when the production of the pre-structured surface on a separate sheet or foil is much more effective than the production of a correspondingly intricate mould, or when the use of metal insert is not practical, for example when its lifetime is limited and it has to be often replaced, or when the complexity of the insert's structure prolongs the production cycle per part, thereby making the production process less economical.

In the field of injection moulding it is also the case that not all micro- or nano-structured in-mould inserts can be easily injection moulded without compromising the optical structure itself, and as a result compromising also its intended optical function. Such micro- or nano-structured in-mould inserts have relief feature sizes typically below 100 micrometres, and even down to nanometre orders of size, and the optical function of such an insert before and/or after it has been combined with an injection moulded part or body depends on the high definition of its optical structural features, i.e. their size, height (or depth), shape and their distribution across the optical surface of the moulded part or body. Thus, in the field of injection moulding of optical elements using known in-mould pre-structured inserts, retention of the optical structure without its losing its form or integrity is of prime concern, and a common problem to be addressed if such techniques are to be practically viable.

Hitherto there have been various proposals for utilising injection moulding for the production of optical components of various kinds, such as those disclosed in WO2014163185A1 (and its corresponding U.S. Ser. No. 10/137,661B1), KR101172814B1, JP2010137493A, WO2016113288A1, U.S. Pat. Nos. 5,189,531A and 5,455,747A. However, none of these prior art proposals goes far enough, or even does anything at all, to adequately address the above problems associated with injection moulding of optical elements using in-mould pre-structured inserts without losses to or compromising of the form and integrity of the optical structures which are so important in the final moulded product. The art therefore still contains a long-felt need which even recent advances in injection moulding techniques as applied to optical components fail to meet

Accordingly, it is a primary object of the present invention to ameliorate, or at least partially solve, the above shortcomings in the known art, and to provide a method or process for injection moulding of an optical component with an incorporated optical structure which substantially eliminates, or reduces to a sufficiently low level the occurrence of, damage or degradation of the optical relief structure during the injection moulding cycle, especially such that the final optical function of the moulded part or body is substantially not negatively affected.

### SUMMARY OF THE INVENTION

In a first aspect, the present invention provides a method for injection moulding an optical component with an incorporated optical function, the component comprising an injection moulded body and at least one optically functional relief structure applied thereto, the relief structure forming or contributing to the optical function of the component to be moulded, wherein the method comprises:
(i) providing an insert comprising the said optical structure in the form of an open-face relief structure provided on a face, surface or portion of the insert,
(ii) mounting the insert inside a mould cavity in which the component is to be moulded, with the open-face relief structure facing and at least partially abutting a surface portion of the mould cavity, and
(iii) rear-injection moulding a body of the component within the mould cavity so as to incorporate the insert in the component body,
wherein the said method is carried out with parameters selected and/or controlled such that during the injection moulding step (iii) the temperature at or on the face, surface or portion of the insert provided with the relief structure remains below the lowest of the glass transition temperature, melting temperature and temperature of onset of thermal decomposition of the material of that face, surface or portion of the insert.

In a second aspect of the invention there is provided an apparatus for injection moulding an optical component with an incorporated optical function, the component comprising an injection moulded body and at least one optically functional relief structure applied thereto, the relief structure forming or contributing to the optical function of the component to be moulded, wherein the apparatus comprises:
(i) a mould including a cavity in which the component is to be moulded;
(ii) means for mounting inside the mould cavity an insert comprising the said optical structure in the form of an open-face relief structure provided on a face, surface or portion thereof, the insert being mountable in the mould cavity with the open-face relief structure facing and at least partially abutting a surface portion of the mould cavity; and
(iii) means for rear-injection moulding a body of the component within the mould cavity so as to incorporate the insert in the component body,
wherein the apparatus comprises means for selecting and/or controlling parameters of the injection moulding such that during the rear-injection moulding of the component body within the mould cavity the temperature at or on the face, surface or portion of the insert provided with the relief structure remains below the lowest of the glass transition temperature, melting temperature and temperature of onset of thermal decomposition of the material of that face, surface or portion of the insert.

In a third aspect the present invention provides an injection moulded optical component with an incorporated optical function, the component comprising an injection moulded body and at least one optically functional relief structure applied thereto, the relief structure forming or contributing to the optical function of the component to be moulded, wherein the optical component is produced by a method according to the first aspect of the invention or any embodiments thereof, or is produced using an apparatus according to the second aspect of the invention or any embodiment thereof.

In a fourth aspect the present invention provides an optical device, especially a light illumination device, such as a luminaire, which comprises at least one injection moulded optical component according to the third aspect of the invention or any embodiment thereof.

In many embodiments of the invention in any of its aspects, the parameter(s) of the injection moulding method, which are selected and/or controlled to achieve the defined temperature limitation on the temperature experienced at or on the face, surface or portion of the insert provided with the relief structure, may additionally be selected and/or controlled such that, during the injection moulding step (iii) of the method, an integral bond is formed or created between the insert and the injection moulded body of the component.

In many embodiments of the invention the insert may take the form of a foil, sheet, film, web or plate of a material, especially of a plastics or polymer (especially a thermoplastic polymer) material.

In some embodiments of the invention in its various aspects, the body of the injection moulded optical component may be of, or may comprise, a material, especially a plastics or polymer (especially a thermoplastic polymer) material, which is compatible with the material of the insert (or the material of a substrate or base layer of the insert, where such a substrate or base layer is present as a discrete layer of the insert) on one or more sides of the insert which come(s) into contact with molten material of the moulded optical component during the injection moulding method. That compatibility may be at least chemical compatibility, such that the polymers of the component body and the insert (or the substrate or base layer thereof, as the case may be) are selected to be either (i) the same polymer material, or (ii) different varieties (e.g. different by molecular weight or chemical substituent(s)) of the same chemical species of polymer, or (iii) of the same chemical class or group of polymers.

Examples of suitable polymers for use independently as the materials of the insert (or the substrate or base layer thereof, as the case may be) and/or the main injection moulded component body may include, among others: polymethyl-methacrylate (PMMA), polycarbonate (PC), styrene-acrylonitrile (SAN), styrene-methyl-methacrylate (SMMA), methylmethacrylate-acrylonitrile-butadiene-styrene (MABS), etc, as well as any combinations or blends of any two or more of the foregoing polymers. Some specific practical examples of combinations of polymers for forming the insert (or the substrate or base layer thereof, as the case may be) and the main injection moulded component body will be discussed and described further below in the context of the more detailed description of features and embodiments of the invention.

In many embodiments the relief structure may comprise optically functional relief with a relief feature average height in a range of less than, or no more than, about 50 micrometres. In many such embodiments the relief feature average height may be in a range of from about 0.25 to about 50 micrometres, especially from about 0.5 to about 20 micrometres, or even more desirably from about 1 to about 10 micrometres. Alternatively or additionally, in some such embodiments the maximum height of the relief features may not exceed about 100 micrometres, and especially may be below about 50 or 20 or 10 or even 5 micrometres.

In many embodiments the lateral (or sideways) sizes or widths of the structural features of the relief structure (e.g. which may typically be defined by the lateral (or sideways) distance or spacing between two neighbouring/adjacent minima or maxima of the profile cross-section) may be in a range of from about 20 or 30 or 40 or 50 nm up to about 200 or 300 or 400 or 500 micrometres, optionally from about 500 nm up to about 200 micrometres, such size measurements being defined and measured in at least in one lateral (or sideways) direction across at least a portion of the relief structure transversely to the general direction of orientation or alignment of the relief features thereof (or of the relief features in that portion of the structure).

However, in certain embodiments it may be that the relief structure may comprise a plurality of, especially an array of a plurality of, individual or discrete relief structure portions whose respective relief features may be oriented or aligned differently or in different directions from those of neighbouring or adjacent or one or more other relief structure portions in the overall relief structure. (For example, the relief structure may comprise an array of a plurality of square, rectangular or other shaped relief structure portions, in each of which portions the orientation or alignment of the relief features is different from that of the relief features in one or more neighbouring or adjacent relief structure portions.) In such cases, therefore, the above-defined lateral (or sideways) sizes or widths of the structural features of the relief structure may instead be defined and measured in at least one lateral (or sideways) direction across at least one of those said relief structure portions transversely to the general direction of orientation or alignment of the relief features in that portion of the structure.

In practical embodiments of the invention in its various aspects, the mounting of the insert inside the mould cavity may be effected or carried out by means of any suitable mounting or attachment means. In various embodiments such mounting or attachment means may comprise one or more of any of the following: electrostatic mounting/attachment means, vacuum-operated mounting/attachment means, mechanical mounting/attachment means, or any combination of any of the aforesaid. Suitable practical examples of each of the above types of mounting/attachment means will be readily known and available to persons skilled in the art of injection moulding.

In some embodiments the mounting of the insert inside the mould cavity, with the open-face relief structure facing and at least partially abutting a surface portion of the mould cavity, may be such that at least one or more portions of the open-face relief structure face and are at least partially in direct contact with one or more surface portions of the mould cavity.

In some embodiments of the invention in its various aspects, the insert may comprise a base or substrate of the material from which the insert is formed, with the optical relief formed directly in or on a surface of the base or substrate material of the insert, for example by a known embossing or imprinting or thermal forming process.

Alternatively, in some other embodiments of the invention in its various aspects, the optical relief may be formed in or on a surface of a discrete or distinct layer (e.g. of a polymer) which is attached to the base or substrate material of the insert. Such a polymer or other discrete/distinct layer may be attached to the base/substrate either by direct bonding/adhesion thereto or by virtue of an adhesive composition or other suitable bonding technique, e.g. via a bonding layer comprising a suitable adhesion promoter or a thin film coating. The polymer or other discrete/distinct layer which is attached to the base/substrate may for instance be formed of a photopolymer or an epoxy compound, and it may have the optical relief applied thereto by any suitable known technique, such as by UV moulding or

UV casting, thermal curing or any other suitable imprinting or moulding technique known in the field of production of microstructures, diffractive structures or holograms. For example, UV curable polymers (e.g. belonging to the group of acrylates, such as acrylated epoxies, which are commonly used in e.g. lithographic inks and varnishes as well as in printed circuit boards and coatings for wood, concrete and plastics, or acrylated polyesters) which exhibit high glass transition temperatures or even do not exhibit properties of materials with glass transition temperatures and which exhibit thermosetting behaviour rather than thermoplastic behaviour (i.e. they do not deform or deform easily at elevated temperatures and pressures) may be especially advantageous materials for the optical relief-bearing discrete/distinct layer. If desired or necessary, the insert may even comprise one or more other layers, in addition to the aforesaid base/substrate and optical relief-bearing discrete/distinct layer, in its overall structure, e.g. for imparting to the insert one or more other desirable properties.

In some such embodiments comprising such a dual- (or multi-) layer insert, the polymers of the base/substrate and of the discrete/distinct layer in/on which the optical relief is formed may be the same or different polymers, or polymers of the same or different chemical classes or groups. In certain ones of such dual-layer embodiments, it may be case that the polymers of the base/substrate and of the discrete/distinct layer in/on which the optical relief is formed are selected such that the respective temperatures being the respective lowest of the glass transition temperature, melting temperature and temperature of onset of thermal decomposition of those respective two polymers are substantially or approximately the same. However, in other ones of such dual- (or multi-) layer embodiments, it may be more desirable that the polymers of the base/substrate and of the discrete/distinct layer in/on which the optical relief is formed are selected such that the lowest of the glass transition temperature, melting temperature and temperature of onset of thermal decomposition of the polymer of the discrete/distinct layer in/on which the optical relief is formed is higher than the lowest of the glass transition temperature, melting temperature and temperature of onset of thermal decomposition of the polymer of the base/substrate layer of the insert. Furthermore, in certain ones of such latter embodiments it may even be the case, even more desirably, that the lowest of the glass transition temperature, melting temperature and temperature of onset of thermal decomposition of the polymer of the discrete/distinct layer in/on which the optical relief is formed is at least about 20% (or even at least about 40 or 50%) higher than the lowest of the glass transition temperature, melting temperature and temperature of onset of thermal decomposition of the polymer of the base/substrate layer of the insert.

In some embodiments of the invention, the insert which is employed—which may include inserts of either a mono-layer or a dual- (or multi-) layer type—may be pre-treated, especially pre-baked or otherwise pre-heat-treated, at a temperature of, or near or approaching or up to, a few or a small number of degrees below (e.g. at least about 0.5 or 1 or 2 or 3 or 4 or 5 or 6 or 7 or 8 or 9 or 10 or 15 or 20 or 25 or 30° C. below) the glass transition temperature (or alternatively the melting temperature if a glass transition temperature is not definable for the material in question, or alternatively still the temperature of onset of thermal decomposition if neither a glass transition temperature nor a melting temperature are definable for the material in question) of the material of at least the body or substrate/base layer of the insert. Such a pre-baking or pre-heat-treatment step may desirably be at a temperature and for a period of time (such as a duration of from about 1 to about 5 minutes), e.g. dependent on the material in question, which is sufficient to ensure that the relief structure layer will substantially not undergo any significant structural changes (such as cross-linking, shrinking, deformation, etc) which could negatively or deleteriously affect the optical function of the relief structure when the temperature of the insert (or of its substrate/base and/or relief structure layer(s)) is elevated to a temperature near or approaching the lowest of the glass transition temperature, melting temperature and temperature of onset of thermal decomposition of the material of the body or substrate/base layer of the insert during the ensuing injection moulding process. Other techniques for pre-treating inserts so that they are able to withstand environmental or other pre-testing steps prior to being applied to the injection moulding process may likewise be employed for the same advantageous reason, if desired or appropriate.

Various other definitions of various features and parameters of the injection moulding process that may be selected or controlled in the practising of embodiments of the present invention in its various aspects will be apparent from the more detailed description hereinbelow of various features and embodiments of the invention as or when put into practice.

In essence, therefore, many embodiments of the present invention are based on the principle that, in the rear-injection moulding of the body of the plastic optical component onto or into unity with the in-mould insert, the parameters of the injection moulding process are pre-designed so as to substantially prevent accumulation of heat at the relief-structured surface or face of the insert that heats it up to (or as far as) or beyond the lowest of its glass transition temperature, melting temperature and temperature of onset of thermal decomposition, and in many cases also (preferably) to create an integral bond between the in-mould insert and the injection moulded body of the component.

Thus, expressed slightly differently, the injection moulding method of the invention may be summarised as being a method of producing a plastic part with an embedded optical function, such as a light distributing or redistributing function (e.g. a cover or other component of a luminaire), where the plastic part comprises an injection moulded body and an open-face micro- or nano-structured relief on at least one of its optically active surfaces or a portion thereof, the micro- or nano-structured relief forming or contributing to the optical function of the plastic part, wherein the method involves selecting and/or controlling the parameters of the injection moulding process such as to avoid or minimise, or substantially eliminate the danger of the occurrence of, damage to or deterioration of the micro- or nano-structured relief surface beyond a point at which its optical function, and consequently also optical function of the part or body to which it is has been injected or bonded, remains viable.

The presently disclosed invention therefore offers a new approach to creating injection moulded parts with inherent optical functionality, e.g. for lighting applications.

The present invention may alternatively be thought of as providing a new method of applying or incorporating an optical function into an injection moulded component, by injection moulding the body of the component in the presence of an insert carrying an optical relief structure with the desired optical function, wherein the parameters of the injection moulding process are selected and/or controlled such as to substantially prevent the accumulation of heat at the site of the optical relief structure that is enough to raise its temperature up to (or as far as) or beyond the lowest of the glass transition temperature, melting temperature and temperature of onset of thermal decomposition of the material in which the optical relief is formed or provided.

Further alternatively still, the present invention may even be thought of as providing a new method of attaching an optical micro- or nano-structure carried by a plastic film, sheet, film, web or plate to an injection moulded component, part or product that is to incorporate the said structure in its final form, the attachment being accomplished by use of an in-mould insert technique for the injection moulding process, by which the optical function is added to the final injection moulded component, part or product substantially without damage to or degradation of the optical micro- or nano-structure by virtue of the parameters of the injection moulding process being selected and/or controlled so as to keep the temperature of the structure below the lowest of its glass transition temperature, melting temperature and temperature of onset of thermal decomposition during the injection moulding procedure.

In practising certain embodiments of the present invention in its various aspects, it is to be understood that some materials usable for the insert, or for a relevant layer thereof, may have a definable glass transition temperature as such (as that term is normally defined and understood in the art). In such cases, therefore, it may be possible for such material(s) to be used for practising embodiments of the invention by reference to its/their “glass transition temperature” alone in the context of the present entire disclosure hereinabove and hereinbelow of embodiments and features of the invention and how to put them into practice.

However, in practising certain other embodiments of the present invention in its various aspects, it is to be understood that some materials usable for the insert, or for a relevant layer thereof, may not have a definable glass transition temperature as such (as that term is normally defined and understood in the art), but nevertheless may have a definable melting temperature (as that term is normally defined and understood in the art). In such cases, therefore, it may still be possible for such material(s) to be used for practising embodiments of the invention by reference instead to its/their “melting temperature” alone and by substituting such materials' definable “melting temperature” for the term “glass transition temperature” in the context of the present entire disclosure hereinabove and hereinbelow of embodiments and features of the invention and how to put them into practice.

Further however, in practising certain yet other embodiments of the present invention in its various aspects, it is to be understood that some materials usable for the insert, or for a relevant layer thereof, may have neither a definable glass transition temperature as such nor a definable melting temperature as such (as each of those terms is normally defined and understood in the art), but nevertheless may have a definable temperature of onset of thermal decomposition (as that term is normally defined and understood in the art). In such cases, therefore, it may still be possible for such material(s) to be used for practising embodiments of the invention by reference instead to its/their “temperature of onset of thermal decomposition” alone and by substituting such materials' definable “temperature of onset of thermal decomposition” for the terms “glass transition temperature” and “melting temperature” in the context of the present entire disclosure hereinabove and hereinbelow of embodiments and features of the invention and how to put them into practice.

Thus, in view of the preceding two paragraphs, where in the detailed description that follows hereinbelow reference is made to a particular material's “glass transition temperature”, this presumes that such a temperature is definable as such for the material in question. However, it is to be understood that such detailed description(s) as hereinbelow is/are to be read and construed as applying equally to other materials that are instead necessarily definable by either: (i) their “melting temperature”, in the event that the material in question does not have a definable glass transition temperature yet does have a definable melting temperature, or (ii) their “temperature of onset of thermal decomposition”, in the event that the material in question has neither a definable glass transition temperature nor a definable melting temperature yet does have a definable temperature of onset of thermal decomposition, as the case may be for any given material in question. The detailed description(s) as hereinbelow should therefore be read and construed accordingly with such alternative or appropriately modified/extended meanings as to its/their scope of applicability.

Furthermore, it may be that in the practising of certain embodiments of the invention, perhaps depending on the precise insert material(s) used and the precise parameters of the injection moulding process, it may be that instead of the primary defining condition being that the method is carried out with parameters selected and/or controlled such that during the injection moulding step the temperature at or on the face, surface or portion of the insert provided with the relief structure remains below the lowest of the glass transition temperature, melting temperature and temperature of onset of thermal decomposition of the material of that face, surface or portion of the insert, it may instead be that the primary condition is that the method is carried out with parameters selected and/or controlled such that during the injection moulding step the temperature at or on the face, surface or portion of the insert provided with the relief structure does not exceed, i.e. it remains below or at most at or near but no more than, the lowest of the glass transition temperature, melting temperature and temperature of onset of thermal decomposition of the material of that face, surface or portion of the insert.

In practical implementations of the present invention in some of its embodiments, the final injection moulded component may be used, for example, as a part of an assembly of a luminaire, such as a planar or curved luminaire cover component which redistributes light incident thereon from a light source, e.g. one or more LEDs, in order to form or contribute to the output light distribution characteristics of the luminaire.

As another example, by use of embodiments of the invention it may be possible to produce a design of luminaire which comprises a given form of transparent injection moulded cover component, but which cover component may be made in a plurality of different versions, each version providing a different output light distribution to be employed as or when required of a particular end-use application. This is made possible without the need to modify the main features or parameters of the injection moulding production process itself, which utilises an in-mould structured insert of a unified form (i.e. in terms of its material and dimensions), it being just the insert's surface relief which is unique thereto and gives the final luminaire its desired final optical output properties.

In yet another example practical application, a resulting injection moulded plastic part may, for example, be a part of a vehicle (e.g. car) headlight or other light, where the micro- or nano-structured surface is part of a planar or curved reflective or transmission optical surface which redistributes light from a light source into a desired radiation or illumination pattern.

Numerous other example practical applications may also be possible by use of embodiments of the invention.

Within the scope of this specification it is envisaged that the various aspects, embodiments, examples, features and alternatives, and in particular the individual constructional, configurational or operational features thereof, set out in the preceding paragraphs, in the claims and/or in the following description and accompanying drawings, may be taken independently or in any combination of any number of same. For example, individual features described in connection with one particular embodiment, or described singly or in combination with another feature in any one or more embodiments, are applicable on their own or in combination with one or more other features to all embodiments and may be found and used in combination with any other feature in any given embodiment, unless expressly stated otherwise or such features are incompatible.

As used herein, the term “optically functional” as applied to the relief structure that is incorporated into the optical component means any relief structure that creates a desired or prescribed output light distribution or redistribution pattern from light emitted by one or more light source(s) at a predetermined location relative to the optical component. In many practical cases such “optical functionality(ies)” may include one or more reflective, transmissive, refractive or diffractive optical functions or behaviours, or any combination of any two or more of the aforesaid optical functions/behaviours.

### BRIEF DESCRIPTION OF THE DRAWINGS

Various features of the present invention, together with various embodiments of the invention in its various aspects, will now be discussed and described in detail, by way of non-limiting examples only, with reference to the accompanying drawings, in which:

FIGS. 1(a), (b), (c) & (d) are sequential schematic views of an injection moulding apparatus carrying out an injection moulding process in accordance with various embodiments of the invention, showing the main process steps for the production of an optical component, which in this illustrated example is an optically functional cover component for a luminaire;

FIGS. 2(a) & 2(b) are schematic cross-sectional views of two different examples of a foil or plate insert with a micro- or nano-structured relief surface, which may be used in the embodiment injection moulding process of FIG. 1;

FIGS. 3(a) & 3(b) are schematic cross-sectional views of a foil or plate insert with a micro- or nano-structured relief surface, in which FIG. 3(a) illustrates the form of the relief according to the theoretical design of the insert and FIG. 3(b) illustrates the form of the relief on the final product which includes various deviations from the designed profile;

FIGS. 4(a), (b), (c) & (d) are radial candela diagrams of various standard types of light distribution curves typically used in luminaires, in which FIG. 4(a) represents a downlight lighting profile, FIG. 4(b) represents an asymmetric lighting profile (e.g. a wall-washer or light with grazing incidence), FIG. 4(c) represents a double-asymmetric lighting profile, and FIG. 4(d) represents a medium-wide (i.e. “batwing”) lighting profile;

FIG. 5 is an example of a typical isocandela diagram representing luminous intensities of a low-beam headlamp of a car or other passenger vehicle, with the peak intensity near the centre;

FIG. 6 is a Table of bond strengths between a variety of different polymer materials combined together in various example injection moulding processes, as provided by the injection moulding machine manufacturer Engel, and as may be consulted and used for the practising of embodiments within the scope of the present invention;

FIG. 7(a) is a simplified schematic cross-sectional view of part of a mould with an insert and injected material, as may typically be employed in the practising of embodiments of the present invention;

FIG. 7(b) is a graph showing a simplified temperature profile at the insert-injected material interface of the arrangement of FIG. 7(a), showing the temperature variation during the injection moulding cycle;

FIG. 8(a) is a side view and FIG. 8(b) is a cross-sectional view (on arrows VIIIb-VIIIB of FIG. 8(a)) of an example of a luminaire assembly comprising a plastic cover component with a nano-structured surface, as produced by an injection moulding process according to a working example embodiment of the present invention;

FIG. 9 is a cross-sectional view of the mould for the injection moulding of the plastic cover component of the luminaire of FIG. 8, showing the placement of a nano-structured foil as an in-mould insert;

FIG. 10 is a cross-sectional view of a test arrangement, showing a sample of an injection moulded component of an embodiment of the invention in the process of being tested;

FIG. 11(a) is a perspective view of a three-dimensional profile of the optical relief of a representative stand-alone nano-structured foil insert sample;

FIG. 11(b) is a graph showing the reference relief profile of the representative stand-alone nano-structured foil insert sample of FIG. 11(a) (i.e. a sample cross-section of the nano-relief), as used to compare degrees of relief profile deformation in various injection moulded components made according to embodiments of the invention;

FIG. 12 is a graph showing the degree of degradation of the relief profile of an embodiment test sample of a nano-structured foil insert incorporated into an injection moulded component according to a working Example as described hereinbelow (under conditions “I”, with foil thickness 125 μm, measured at locations 1 to 4);

FIG. 13 is a schematic sectional view of a test arrangement for the measurement of output light distributions of test samples of injection moulded nano-structured optical components produced using embodiments of the invention;

FIGS. 14(a), 14(b), 14(c) & 14(d) are graphs showing the results of tests of the optical functionality of various sample injection moulded optical components (namely various injection moulded foil inserts employed in accordance with embodiments of the invention);

FIG. 15 is a graph showing the profile shapes of the nano-structure relief on various insert versions used in various test injection moulding cycles;

FIG. 16(a) is a graph showing the profile shapes of the nano-structure relief on various sample injection moulded components made according to embodiments of the invention, showing the profile shapes at location 2 on the final components in question in comparison with the reference profile of the insert before the moulding cycle (curve C);

FIG. 16(b) is a graph showing the profile shapes of the nano-structure relief on the sample injection moulded component using a 175-micrometre thick insert (made according to an embodiment of the invention), showing the profile shapes at locations 1 to 4 on the final component; and

FIG. 16(c) is a graph showing the profile shapes of the nano-structure relief on the sample injection moulded component using different thicknesses of inserts and different thicknesses of layers of UV polymer with nano-relief at location 2 on the final component.

### DETAILED DESCRIPTION OF THE INVENTION AND ITS EMBODIMENTS

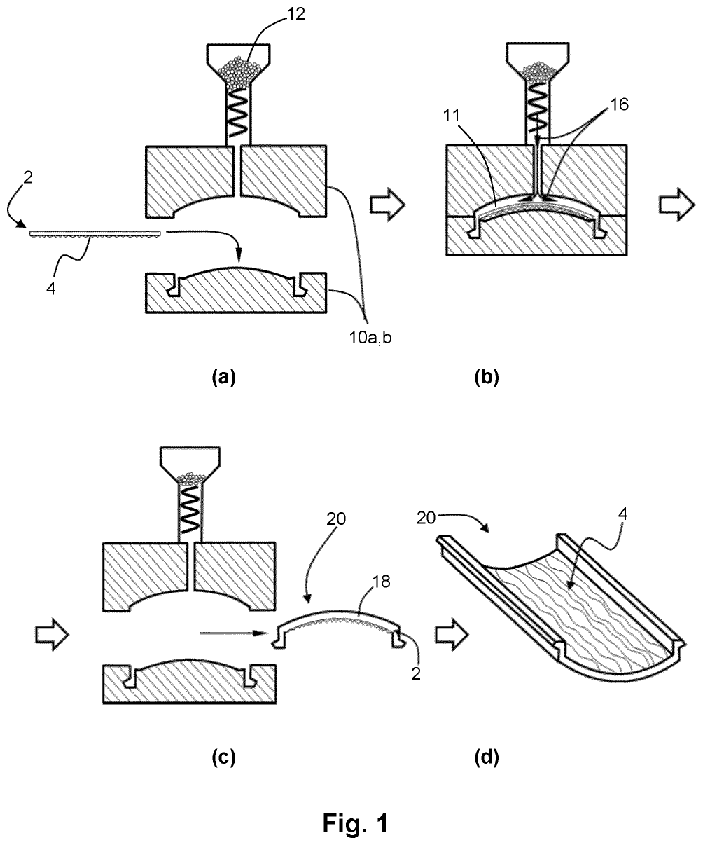

FIGS. 1(a), (b), (c) & (d) are schematic views of the various process steps used to injection mould an optical component 20 according to one or more embodiments of the invention. In this illustrated example, the optical component 20 is an optical functional transparent cover for a luminaire, which cover incorporates micro- or nano-structured optical functional relief 4 on an inner surface thereof to impart to the cover component 20 a desired specific optical function for creating a desired output light distribution of the final luminaire.

As shown in simplified cross-section in FIGS. 1(a)-(c), the injection moulding apparatus comprises lower and upper mould parts 10a, 10b which are brought together to define a mould cavity 11 therebetween, into which cavity 11 is fed pellets of raw plastic material 12 and heated in order to form the injection moulded part or body within the mould by melting and flowing of the molten plastic material. Prior to the closure of the mould parts 10a, 10b, as shown in FIG. 1(a), there is inserted into the cavity 11 a thin insert 2 which has formed on a lower face or surface thereof (which is that face/surface which faces and contacts the lower mould part 10a, which is opposite to the side of the mould from which the injection moulded material 12 is fed into the mould through the upper mould part 10b) an open-face micro- or nano-structured optical relief 4. At this stage the insert 2 is held in position against the surface of the lower mould part 10a by either an electrostatic, mechanical or vacuum device (not shown), in accordance with known injection moulding processes which incorporate inserts into injection moulded articles. Thus, as shown in FIG. 1(b), upon heating of the rear-injected plastic material 16, it flows within the mould cavity 11 to form the moulded luminaire cover component 20, and at the same time the insert 2 becomes integrally incorporated into the body of the final component 20. As shown in FIG. 1(c), once it has sufficiently cooled the complete injection moulded cover component 20, incorporating the micro- or nano-structured optical relief insert 2 is then removed from the mould, after having separated the mould parts 10a, 10b, leaving the finished moulded optically functional luminaire cover component 20, as shown in FIG. 1(d).

The injection moulding process outlined above and shown schematically in FIGS. 1(a)-(d) involves various features and parameters which may be selected and/or varied in accordance with carefully controlled or selected criteria in order to achieve the desired thermal distribution characteristics in the part or parts of the mould that are adjacent to or contact the structural relief surface/face 4 of the insert 2 during the injection moulding cycle and are central to the present invention and the attainment of its stated object(s). These various features and parameters are discussed and described below, and form the basis for implementing various practical embodiments of the present invention in its various aspects.

### The Plastic Insert

The plastic insert carrying a texture or an imprint of a relief micro- or nano-structure may usually be provided in the form of a foil, sheet, film, web or plate, especially a thin such foil/sheet/film/web/plate, which may generally have a thickness in a range of from about 25 micrometres (microns) to about 2 mm, especially in a range of from about 50 micrometres (microns) to about 1 mm. In many typical or desirable practical embodiments the foil/sheet/film/web/plate thickness may be in a range of from about 100 to about 250 or 500 micrometres (microns). Thinner foils/sheets/films/webs/plates may help to ensure enough flexibility in the insert 2 such that it is able to readily conform to an inner surface/face of the mould (e.g. lower mould part 10a in FIG. 1(a)) by application of an electrostatic or vacuum or mechanical force in cases where that inner surface/face of the mould is curved, especially curved primarily in one dimension.

### The Micro- or Nano-Structured Optical Relief

In some embodiments the micro- or nano-structured optical relief of the plastic insert may be formed directly in or on a surface of a base or substrate material of the foil, sheet, film, web or plate, for example by a known embossing or imprinting or thermal forming process.

Alternatively, in other embodiments the micro- or nano-structured optical relief of the plastic insert may be formed in or on a surface of a discrete or distinct layer (e.g. of a polymer) which is attached to the base or substrate material of the foil, sheet, film, web or plate. The polymer or other discrete/distinct layer which is attached to the base/substrate (e.g. by an adhesive or other suitable bonding technique) may for instance be formed of a photopolymer or an epoxy compound, and it may have the micro- or nano-structured optical relief applied thereto by any suitable known technique, such as by UV moulding or UV casting, thermal curing or any other suitable imprinting or moulding technique known in the field of production of microstructures, diffractive structures or holograms.

In many embodiments the micro- or nano-structured relief may be formed in or on one face only of the foil, sheet, film, web or plate substrate or the discrete/distinct layer attached thereto. The relief may be applied to one or more portions of the relevant face, i.e. either to only a part or one or more parts of that face or alternatively to substantially the whole thereof.

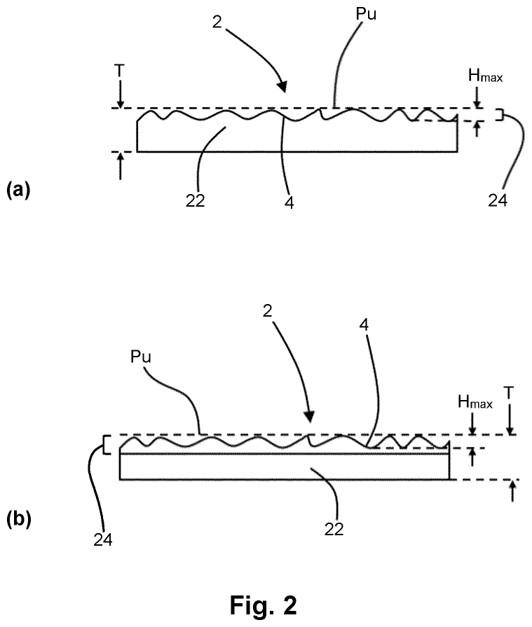

FIG. 2(a) illustrates an embodiment insert 2 in which the micro- or nano-structured optical relief 4 is applied directly to the foil/sheet/film/web/plate substrate or base material 22. Here, T represents the maximum thickness of the insert 2, Pu represents the plane of the unstructured surface of the insert 2, and Hₘₐₓ represents the maximum profile height of the height portion of the substrate or base material 22 which constitutes the relief layer 24 thereof.

FIG. 2(b) illustrates an embodiment insert 2 in which the micro- or nano-structured optical relief 4 is applied indirectly to the base or substrate material 22 of the foil, sheet, film, web or plate of the insert by virtue of it being applied to a discrete or distinct polymer layer 24 which is attached to the upper surface/face of the foil/sheet/film/web/plate substrate or base material 22. Here, T again represents the maximum thickness of the insert 2, Pu again represents the plane of the unstructured surface of the insert 2, and Hₘₐₓ represents the maximum profile height of the relief layer formed in/on the discrete/distinct polymer layer 24.

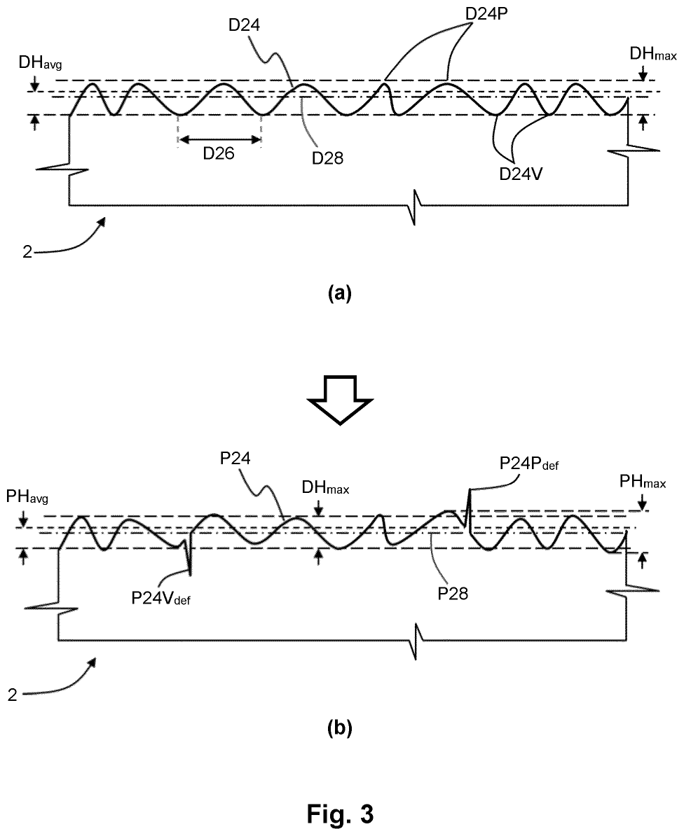

In general, in many embodiments of the invention, the profile height of the micro- or nano-relief structure may vary or oscillate, especially periodically or quasi-periodically or even quasi-randomly or irregularly, between maximum (i.e. peaks) and minimum (i.e. valleys) profile points passing across (e.g. lengthwise or widthwise/transversely/laterally or sideways across) the relief structure in one or more, possible even in a plurality of or in varying, directions substantially parallel to the general plane of the foil/sheet/film/web/plate of the insert. (As an aside, however, note that in a case where the relief structure comprises an array of a plurality of discrete relief structure portions whose respective relief features are oriented differently or in different directions from those of neighbouring or adjacent portions of the relief structure (e.g. in the case of an array of a plurality of square, rectangular or other shaped relief structure portions, in each of which the orientation of the relief features is different from that of the relief features in one or more neighbouring or adjacent relief structure portions), then in such a case the lateral (or sideways) sizes or widths of the structural features of the relief structure may be defined and measured in at least one lateral (or sideways) direction across at least one of those said relief structure portions transversely to the general direction of orientation or alignment of the relief features in that portion of the structure.) This may be valid for at least one of, or each of, such profile cross-section(s) made practically at any point of the relief structure in at least one direction. In general, the majority of the peaks (i.e. profile tops) may lie in or in close proximity to or adjacent a plane substantially parallel to the general plane of the foil/sheet/film/web/plate of the insert, and the same may apply to the valleys (i.e. profile bottoms). This may be true especially for the theoretically designed relief structure. In reality, however, in implementing some practical embodiments, due to imperfections in the production of the relief structure the peak and/or valley heights may become more uneven, or there may occur some high point(s) or low point(s) or area(s) below the general plane of the peaks or valleys which are considered as defects, rather than a part of the relief profile as such. These possibilities are illustrated in FIGS. 3(a) & 3(b), where FIG. 3(a) shows a schematic cross-section of a foil, sheet, film, web or plate insert 2 with a micro- or nano-structured relief surface according to the theoretical design therefor, whilst FIG. 3(b) shows the schematic cross-section of a real-life foil, sheet, film, web or plate insert 2 in a final product showing the micro- or nano-structured relief surface with various deviations from the theoretical designed profile. In FIG. 3(a): D24 represents the relief profile as per the theoretical design thereof, D24P represent the relief profile peaks, D24V represent the relief profile valleys, D26 represents the lateral relief feature size, DHₘₐₓ represents the maximum height of the theoretically designed profile, DH_{avg} represents the average height of the theoretically designed profile, and D28 represents the theoretically designed profile plane fit. In FIG. 3(b): P24 represents the relief profile of the final real-life product, P24P represent the relief profile peaks of the final real-life product, DHₘₐₓ again represents the maximum height of the theoretically designed profile, PHₘₐₓ represents the maximum height of the real-life product's profile, PH_{avg} represents the average height of the real-life product's profile, P28 represents the real-life product's profile plane fit, P24P_{def} represents a real-life high-point profile defect, and P24V_{def} represents a real-life dig/scratch/stitch line (or seam) profile defect.

Thus, as illustrated in FIG. 3(a) and preferably as carried through into the final real-life product as illustrated in FIG. 3(b), the even or nearly even height of the resulting profile peaks P24P—which is to say, the predominantly or approximately or substantially wholly preserved heights of the real-life profile peaks P24P as compared with their corresponding theoretical designed configurations—may be advantageous when the insert 2 is attached to the mould, since in that case the peaks P24P (and thus also the foil, sheet or plate substrate 22 of the insert 2 itself) may conform better to the mould surface.

From the measurements of distances of each point on the profile P24 from the profile plane fit P28 (i.e. a plane fit through all relief points of the micro- or nano-structured surface), the maximum and average profile height can be determined. The maximum height is usually defined as the distance between two most distant points from the plane fit, one above and one below the plane. This is true especially for the theoretical profile designs. In reality, however, the maximum profile height may be alternatively (and more accurately) understood in terms of the distance between peak and valley planes (which exclude outliers such as random high or low points—as shown in FIG. 3(b)). Further alternatively, the maximum profile height may instead be defined by a maximum amplitude of the profile oscillations measured across the relief structure.

The average profile height (or the effective profile height) may be defined as the sum of the average distances of relief points above and below the relief plane fit P28. The average height is always smaller than or at most equal to the maximum height. The average profile height of the micro- or nano-structured surface relief may typically be in a range of from about 0.25 to about 50 micrometres, especially from about 0.5 to about 20 micrometres, or even more desirably from about 1 to about 10 micrometres, or possibly even from about 1 to about 3 micrometres. The maximum height of such a relief may not exceed about 100 micrometres, and in most practical embodiment cases it may be below about 50 or 20 or 10 or even 5 micrometres.

In general, the actual relief height may be measured relative to the plane of the unstructured surface of the material in which the relief is formed or relative to the plane of the substrate's unstructured surface. In reality, however, there may be some discrepancy between the planes of the unstructured and structured surfaces, since the moulding process may deform the original plane, i.e. make it uneven or tilted, or it may even contain some relief defects (such as seam lines, digs, scratches or spikes, as illustrated by way of example in FIG. 3(b)). This “unevenness” may, however, be of macroscopic character, with variations in the order of hundreds of micrometres or millimetres, and in general such unevenness may not be intentional in a sense of the structured surface's functionality. Therefore, in the practising of embodiments of the present invention, to determine the maximum or average height of the micro- or nano-structured relief in such embodiments the profile height may be measured locally, which is to say across one or more areas usually smaller than (or equal to) 1 mm in diameter, or possibly even smaller than (or equal to) 0.5 mm or perhaps even 0.1 mm in diameter, so as to preferably cover (or include) at least around 5 to 10 relief oscillations. The above-mentioned typical maximum or average profile height values or ranges may then apply to any such measurement area at any location on the micro- or nano-relief structure of the insert (and apart from any defective locations).

The lateral sizes D26 of the structural features (which are typically delimited by two neighbouring local minima or maxima of the profile cross-section) may vary significantly. However, they may typically be in a range of from several tens of nm (e.g. from about 20 or 30 or 40 or 50 or 60 or 70 or 80 or 90 or 100 nm) up to a few hundreds of micrometres (e.g. up to about 200 or 300 or 400 or 500 micrometres), optionally from about 500 nm up to about 200 micrometres, such size measurements being defined and measured in at least in one lateral direction across a given portion of the relief structure, as shown in FIGS. 3(a) & 3(b). (Note again here the “aside” comment hereinabove regarding how the lateral (or sideways) sizes or widths of the structural features of the relief structure are defined and measured in the case of a relief structure which comprises an array of a plurality of discrete relief structure portions whose respective relief features are oriented differently or in different directions from those of neighbouring or adjacent portions of the relief structure. In other words, the defined cross-section does not have to follow only a straight line but it may be of a variable direction of any kind.)

### The Optical Function of the Relief Structure

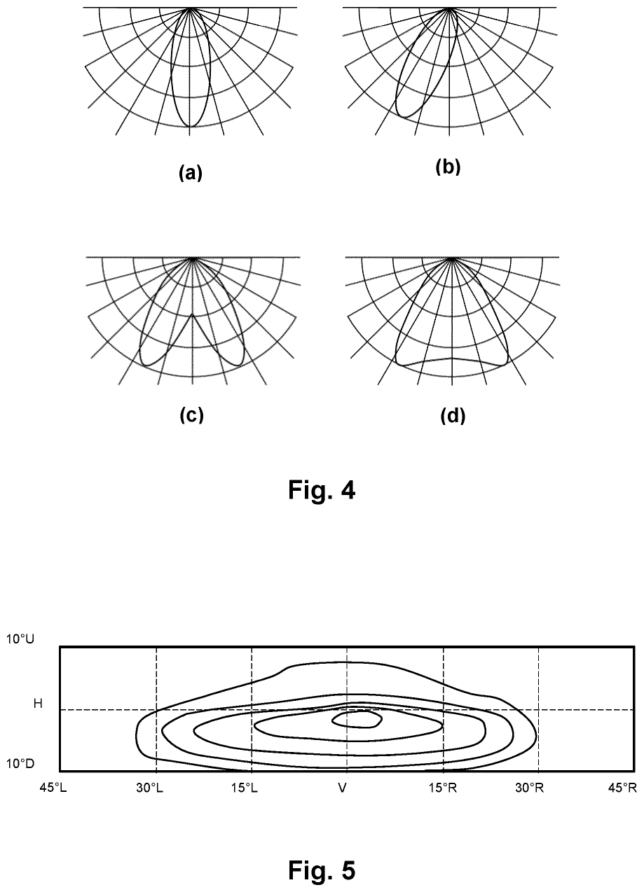

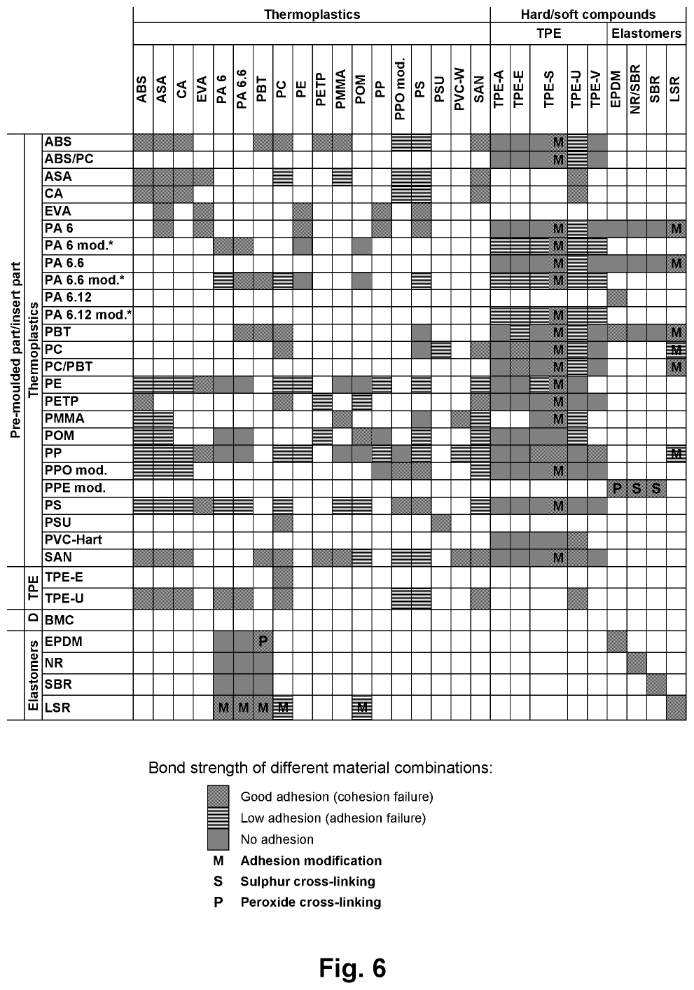

The optical structure of the insert, i.e. the micro- or nano-relief texture or imprint, and therefore also its optical function, may be designed for a specific shape and configuration of the moulded part in a given optical end-application, for example as may be required of the final moulded optical component in an illumination application or in the automotive industry, to name but a few determining end-applications. The design of the optical micro- or nano-structure may for example involve standard ray-tracing modelling, and in many cases it may employ specialised computer software for modelling coherent or incoherent scatter. Some examples of light distribution functions (i.e. angular distribution of light intensity), typically for indoor luminaires, are shown schematically in FIG. 4, in which FIG. 4(a) shows a typical downlight lighting profile, FIG. 4(b) shows an asymmetric lighting profile (e.g. a wall-washer or light with grazing incidence), FIG. 4(c) shows a double-asymmetric lighting profile, and FIG. 4(d) shows a medium-wide (i.e. “batwing”) lighting profile. Each of these light distribution functions may be provided in many different variations, e.g. presenting different values of angular spread, beam tilt or shape or peak intensity properties. Likewise, FIG. 5 shows a typical isocandela diagram representing luminous intensities (with the peak intensity near the centre) of a low-beam headlamp of a car or other passenger vehicle, again which can vary in its precise configuration.

Insertion of the Insert into the Mould

When the insert is placed into the mould it may be applied to any surface of the mould cavity, e.g. a portion of the mould being or comprising or forming part of a movable plate or stationary plate, in order to become attached to a desired side or surface of the final moulded component during the injection moulding process. In the mould the insert's face/side with the micro- or nano-structured relief may face the wall of the mould, and its opposite face/side may thus face the mould's internal cavity and become attached to or united with the final injection moulded component body.

The insert may be held in place or in position in the mould by any suitable holding or retention or stabilising means, for example by one or more electrostatic devices or vacuum-operated devices (e.g. in which air is sucked out of the mould cavity via one or more, optionally a plurality of, channels or holes formed in or built into the mould's walls), or by any suitable mechanical means, or alternatively by a combination of any two or more of the foregoing holding/retention/stabilising means. Suitable practical examples of such electrostatic, vacuum or mechanical holding or retention or stabilising means are readily available in the art and will be readily understood and utilisable by persons skilled in the art of injection moulding.

Since the structured surface of the insert is preferably in contact with a wall of the mould which is heated during the injection moulding process, the overall process parameters need to be carefully designed so as not to cause destruction or damage to the structured relief which would consequently also destroy the optical function of the final moulded component or part, and this one of the important features that makes possible the working of embodiments of the present invention.

### Materials Used and the Forming of an Integral Bond

The base or substrate material of the in-mould insert may be a polymer or synthetic material, especially a thermoplastic polymer, which is physically and/or chemically compatible with the material (especially a thermoplastic plastic material) used to form the injection moulded component's main body, in order that the insert can form an integral, especially a strong and stable and intimate, bond between the two materials during the in-mould insert injection moulding process. In many practical embodiments, both materials may be of the same general type or group, i.e. of the same chemical class or group, such as amorphous or semi-crystalline polymers. The two materials may even be of the same species, if not the same class or group. It may be especially advantageous to employ pairs of materials for the insert and the main component body which have similar (or substantially or approximately the same) melting temperatures and/or similar (or substantially or approximately the same) glass transition temperatures, since this may also help to minimise stresses in the bond formed between the two elements when the final injection moulded component or part is cooled down to ambient temperature.

Examples of suitable polymers for use independently as the materials of the insert and/or the main injection moulded component body may include, among others: polymethyl-methacrylate (PMMA), polycarbonate (PC), styrene-acrylonitrile (SAN), styrene-methyl-methacrylate (SMMA), methylmethacrylate-acrylonitrile-butadiene-styrene (MABS), etc, as well as any combinations or blends of any two or more of the foregoing polymers.

The use of the same type (i.e. chemical class or group) of material in the two elements (i.e. the insert and the main injection moulded component body) may be especially preferred in the production of optical components based on transparent materials, where the optical functionality of the final injection moulded component or part with the micro- or nano-relief is achieved through light transmission. The use of the same materials (or same class of materials) in the two cases may furthermore serve to eliminate or minimise refractive index mismatches between the insert and the injection moulded component body, and/or the visibility of any residual interfaces between the insert and the injection moulded component body.

In general, the integral bond formed between the injection moulded component body and the in-mould insert may be achieved when the injected molten material merges or fuses with the surface layer of the insert which has been softened by an increase in temperature, owing to its contact with the molten material. The basic rule here is that the temperature of the bonding surface layer of the insert (i.e. the opposite side or face of the insert's main body or substrate/base layer from the side or face thereof with the optical relief provided therein/thereon) should preferably increase to above the glass transition temperature (and/or even the melting temperature) of the material of the insert's main body or substrate/base layer. Nevertheless, it may even be possible for the injected molten material itself to be at a temperature significantly higher than its glass transition temperature (and/or its melting temperature), e.g. even up to about 2 times its glass transition temperature (and/or its melting temperature).

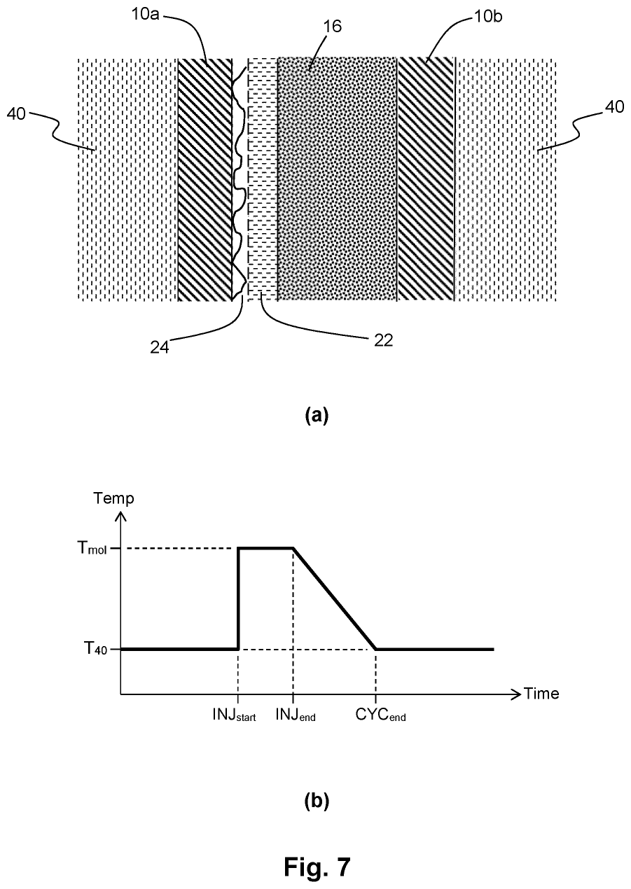

Apart from the temperature relationship between the insert and the molten material being injected, it is also important to ensure that the chosen materials are compatible with each other so as to be able to form the integral bond. Combinations of synthetic or polymer materials which can form integral bonds therebetween are well-known in the injection moulding industry and can be found in various publications, and they are often provided for reference by manufacturers of injection moulding machines. An example of one such reference source is shown in FIG. 6 (the contents of which Table are incorporated herein by reference), which is a Table of bond strengths between a variety of different polymer materials combined together in various example injection moulding processes, as provided by the injection moulding machine manufacturer Engel.

For use in practising embodiments of the present invention, any of the polymers or other materials disclosed in this Table may be employed independently for each of the materials of the insert and of the main injection moulded component body, provided that the relevant combination of such polymers/materials satisfies the compatibility criteria as demanded or desired of the particular embodiment in question. Thus, in many embodiments of the invention, at least those combinations of polymers/materials labelled as “good adhesion”, or in certain cases those labelled as “low adhesion” (or alternatively still certain ones of other combinations labelled other than either of the aforesaid), may be employed to good or satisfactory effect.

### Bond Testing

When the plastic in-mould insert is rear injected with the molten material to create the final combined body of the injection moulded component or part, after cooling it may be useful or important to verify the integrity of the bond between the two elements. Different end-applications may require different strengths of the bond or different resistances to various environmental conditions. In the case of transparent materials, a visual check of defects at the interface between the insert and the plastic component body, e.g. by the naked eye or under a microscope, may give a useful first indication of a successful, or unsuccessful, bond. In the case of a foil or sheet insert, a standard tape test, or scratch test or pull-off test, may alternatively or additionally be applied to test the strength of the bond. These standard types of tests—such as ISO 2409 for a cross-cut test, ISO 4624 for a pull-off test for adhesion, as well as their ASTM equivalents, and possibly others—have often been used for the testing of adhesion of paints or varnishes, but they may also be used successfully (or easily adapted, if need be) for testing bonds or adhesion of different materials, including rear-injected inserts, in the implementing of embodiments of the present invention. These tests may additionally be used in combination with environmental testing (e.g. for temperature and humidity cycling) according to the needs of the final product application.

### The Injection Moulding Cycle

When the materials of the in-mould insert and the injection moulded component body have been selected, it is generally important to design the mould and injection moulding cycle parameters using any or at least some of (or possibly even most or all of) the generally accepted design rules and guidelines used in the art of injection moulding for successful production of the desired final optical component or part with the integral rear-injected in-mould insert forming part thereof.

This general principle may include the design of the parts of the mould, such as its one or more cavities, hot/cold runner systems, feed and cooling systems, guide pillars, ejector plate system, etc for the injecting of molten material, mounting (or securement or stabilising) features for the insert (e.g. vacuum channels), components of the cooling circuit, as well as various operational parameters of the injection moulding cycle itself, such as temperature of the mould, pressure and temperature of the injected molten material, injection time/duration, cooling time/duration, etc. Any successful design may utilise additional expertise in the art gleaned from or aided by various computer software or software packages already in use in the industry, such as MoldFlow [trade mark], Moldex3D [trade mark], Cadmould [trade mark], SolidWorks Plastics [trade mark], and others.

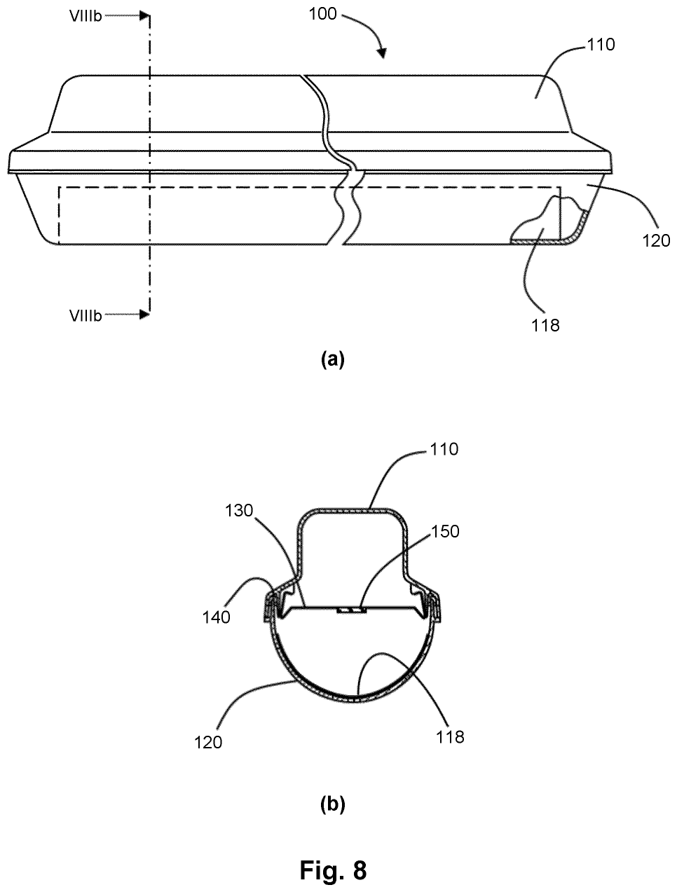

FIG. 7(a) illustrates schematically in cross-section a typical in-mould arrangement as may typically be found in the practising of embodiments of the invention, in which a mould, with mould parts 10a, 10b contacted by preheating/cooling fluid 40, has insert 22, 24 located therein (22 being its base/substrate and 24 being its relief structured layer), and molten material 16 has been rear-injected behind it to form the main body of the finally moulded component or part.

In the practising of embodiments of the present invention, during the design of the entire injection moulding process specific consideration needs to be given to the maximum temperature of the insert at the location where the micro- or nano-structured relief is situated and at which it becomes incorporated into the final injection moulded component or part during the injection moulding cycle. Such a temperature must remain below the glass transition temperature (or alternatively the melting temperature if a glass transition temperature is not definable for the material in question, or alternatively still the temperature of onset of thermal decomposition if neither a glass transition temperature nor a melting temperature are definable for the material in question, as appropriate—see above) of the material of the insert, or at least of the material of its substrate or other layer in or on which the micro- or nano-structured relief is formed or provided.

### Modelling

In putting into practice embodiments of the present invention, to ensure the above guiding principle is met or adhered to—i.e. that the maximum temperature of the insert, at the location where the micro- or nano-structured relief is situated and at which it becomes incorporated into the final injection moulded component or part during the injection moulding cycle, remains below the glass transition temperature (or alternatively the melting temperature if a glass transition temperature is not definable for the material in question, or alternatively still the temperature of onset of thermal decomposition if neither a glass transition temperature nor a melting temperature are definable for the material in question, as appropriate—see above) of the material of the insert, or at least of the material of the layer in or on which the micro- or nano-structured relief is formed or provided—the thermal flow throughout the molten material and the insert and the mould may be modelled in order to determine the maximum temperature of the insert at the location of the micro- or nano-structured relief after the molten material of a preset temperature has reached the insert having been injected into the mould during the moulding cycle.

This may not be an easy task, since the process may be very dynamic and material properties may change with changes of temperature over time, and such behavioural parameters may not be explicitly known. Therefore, as a “worst case” boundary condition for solving the above heat conduction “equation” (i.e. the criterion for the limit on the temperature experienced at the location of the relief structure on the insert), it may be assumed that the temperature profile in time at the insert's side facing into the mould's cavity is initially equal to the temperature profile of the pre-heated mould, it then rises immediately to the temperature of the injected molten material and remains at that temperature until the injection of the material is finished, and then the temperature linearly drops down to the cooling temperature (which typically may be the same as the temperature of the pre-heated mould) at the end of the injection moulding cycle. This thermal behaviour—as observed in the typical arrangement shown in FIG. 7(a)—is illustrated schematically in FIG. 7(b), in which T₄₀ represents the preheating/cooling temperature of the preheating/cooling fluid 40, Tₘₒₗ represents the temperature of the molten material being injected, INJₛₜₐᵣₜ represents the start time of the injection step, INJ_{end} represents the end time of the injection step, and CYC_{end} represents the end tie of the overall injection moulding cycle.

During this time of elevated temperature within the injection moulding cycle, heat is being transferred from the insert-molten material interface through the insert thickness to the relief layer and further through to the mould's adjacent wall to the wall's side in contact with the cooling fluid where it is assumed to be at the constant temperature of the coolant. If the modelled temperature at the structured relief surface of the insert does not reach (i.e. it remains below) the glass transition temperature (or alternatively the melting temperature if a glass transition temperature is not definable for the material in question, or alternatively still the temperature of onset of thermal decomposition if neither a glass transition temperature nor a melting temperature are definable for the material in question, as appropriate—see above) of the base/substrate material of the insert or at least of the layer of the insert in or on which the micro- or nano-structured relief is formed or provided, then the preset thermal conditions of the injection moulding cycle may be deemed to be acceptable. Otherwise, i.e. if such a condition of the modelled temperature is not met, the parameters of the injection moulding cycle may need to be recalculated. Alternatively, however, the actual in-mould insert injection moulding cycle could be tested experimentally to verify in practice whether the relief micro- or nano-structure of the insert withstands or has withstood the injection moulding cycle conditions, and if not the parameters of the cycle need to be adjusted accordingly, until the required meeting of the above criterion is achieved.

In a case where, after plural iterations (or recalculations or experimental testings), the suitable or optimum conditions/parameters have not been found (e.g. they are not sufficient to reliably create an inseparable integral bond between the insert and the injection moulded body, or they cannot prevent damage or distortion of the relief structure), then it may for instance mean that the selected insert is inherently not suitable for the desired injection moulding process using that insert. Therefore, a different insert selection may then need to be made, e.g. using a different form of insert with a different thickness, or based on a material with a higher glass transition temperature (or alternatively melting temperature if a glass transition temperature is not definable for the material in question, or alternatively still temperature of onset of thermal decomposition if neither a glass transition temperature nor a melting temperature are definable for the material in question, as appropriate—see above) of its micro- or nano-structured relief layer.

### Working Example

There now follows a more detailed description of a working example embodiment of an injection moulding process according to the present invention and how it may be put into practice, in order to more fully demonstrate many of the principles and steps that may be followed in the practising of a variety of embodiments of the present invention.

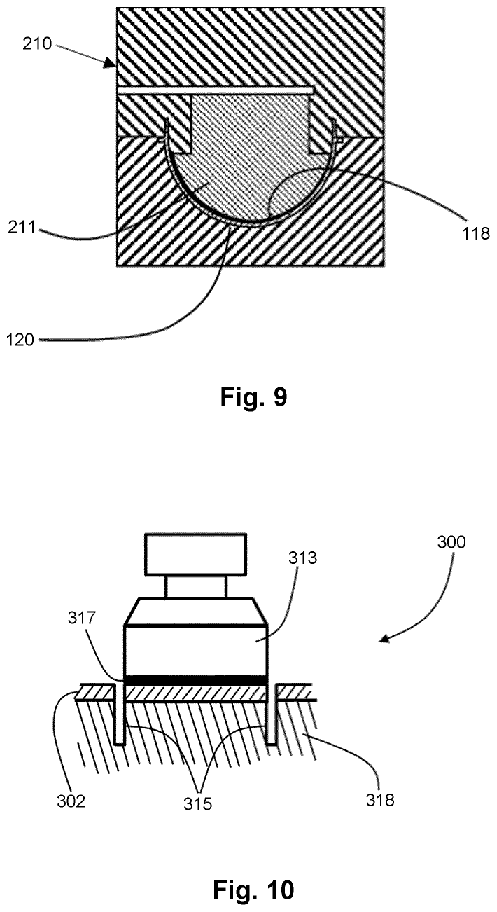

The above more general disclosure of many of the key features of embodiments of an injection moulding process according to the invention will therefore now be augmented by the following description in further detail, by way of example only, of a specific working practical example of the production of a plastic optical component or part with a surface nano-relief providing optical functionality to the moulded plastic component/part. In this case the goal was to produce a plastic transparent cover for an LED-based luminaire as shown in FIGS. 8(a) & 8(b).

As shown in FIGS. 8(a) & 8(b), the LED luminaire 100 comprised a body 110, a reflector 130 with electrical and/or electronic components mounted thereto/thereon, LEDs 150 and a transparent plastic cover 120 attached to the body 110 via joints or connector elements 140 incorporating a suitable elastomeric sealant material. The transparent plastic cover 120 was made by an injection moulding process according to an embodiment of the invention, in which an in-mould insert 118—namely a foil carrying a nano-relief with an optical functionality (e.g. light output distribution characteristics) designed specifically for this particular LED luminaire 100—was rear-injected along with the plastic cover's body to form the unitary injection moulded transparent cover 120 with the inherent optical functionality. The insert 118 comprising the foil carrying the open-face nano-relief was rear-injected with the material forming the cover body on the opposite side of the insert 118 to that carrying the nano-relief, i.e. the insert 118 was rear-injected on what was to become the cover 120's outer side, with its inner side of the cover 120 facing the LEDs 150 and towards the interior of the luminaire 100 displaying the final nano-relief in the finished cover 120.

The material of the transparent plastic cover 120 was polycarbonate (Makrolon® 2207, from Covestro), as was also the base material of the foil insert (Lexan™, from Sabic).

### The Mould

An industry standard process for the design of the mould for injection moulding the luminaire cover was applied with a consideration for inserting into the mould a foil insert with a thickness of from about 125 to about 250 micrometres.

The mould was designed with vacuum channels for attaching the insert to the wall of the mould. The mould was designed for the injection moulding machine Engel Duo 1100. The injection moulding process was tuned with a foil 0.125 mm thick.

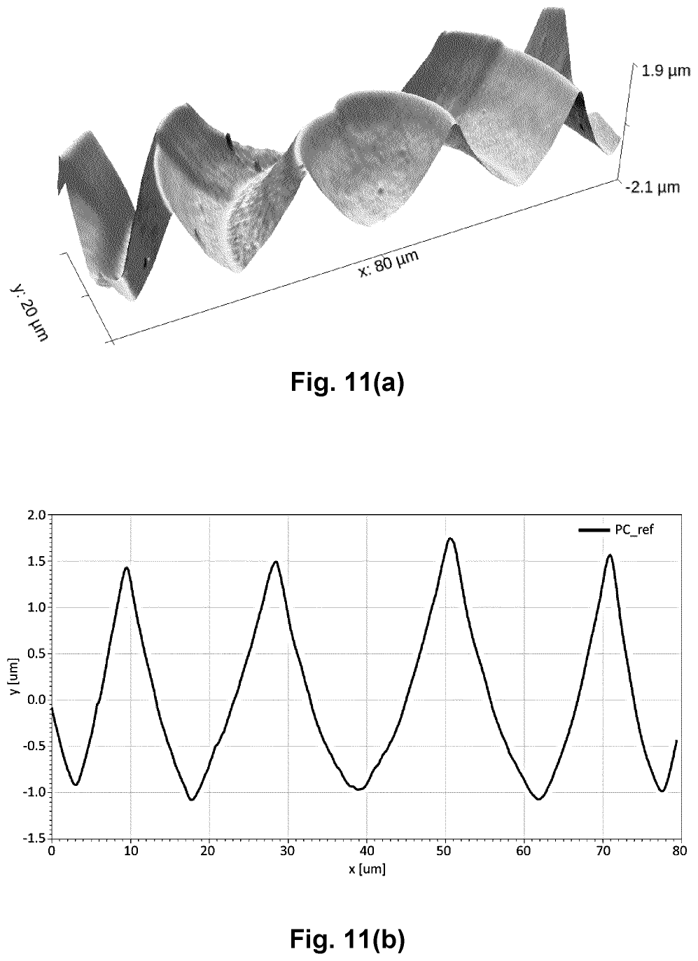

As shown schematically in FIG. 9, the foil 118 was inserted into the mould 210, in which it was attached onto the core 211 of the mould by means of a vacuum applied through channels (not shown) in the core 211, ready for being rear-injected with the material to form the main convex/arcuate body of the cover 120 (i.e. with the resulting nano-relief on the cover 120's inner side).

### The Moulding Process Parameters

In the first pre-production step, the basic ranges of various parameters or working conditions of the injection moulding process for successful moulding of the plastic cover and for creating an integral bond with the foil insert were determined for polycarbonate (PC). These were, specifically:
melt temperature range: 280-320° C. (optimum: 305° C.);
barrel temperature—nozzle range: 280-300° C. (optimum 305° C.);
mould temperature range: 60-120° C. (optimum: 80° C.);
hold pressure range: 50-75% of the injection pressure (optimum 50%);
injection pressure: 120-220 bar (optimum 140 bar);
injection time range: 1-5 s (optimum 1.4 s);
after pressure time range: 1-5 s (optimum 1.5 s).

The application of the above parameters within these above ranges was found to ensure the creation of an integral bond between the insert and the injected plastic body.

The testing of the product was based on a set of standardised tests. The adhesion test (i.e. bond strength test) and optical performance test (i.e. measuring light distribution curves, i.e. intensity distribution curves) were carried out before and after testing the final product in an environmental chamber (to test for resistance to hot and freezing temperatures).

### Assessing the Adhesion

Evaluation of the adhesion of the injected foil insert onto the injection moulded body was carried out by application of an adhesion test for paints, varnishes or powder coatings. These are standard cross-cut and pull-off tests according to EN ISO 2409 and EN ISO 4624, respectively. Although these tests have been originally designed for a slightly different purpose, they proved to be adequate for testing the bond between the plastic foil in-mould insert and the injected plastic body made according to this embodiment of the invention.

### Cross-Cut (Lattice) Adhesion Test

The EN ISO 2409 standard specifies a test method for determining the resistance to separation of the paint from the substrate when the paint is cross-cut (in a lattice pattern) all the way through to the substrate. An ELCOMETER 141 Paint Inspection Gauge tool set (including cutter with handle, adhesion tape according to ISO 2409 specification—i.e. 25 mm wide, adhesion 10±1 N per 25 mm width (according to IEC 454-2), magnifying glass, brush) was used for testing. The test was performed by the following procedure: The sample was placed on a flat rigid base plate. Two cuts were made into the injected insert using the cutter, first in one direction and then in the perpendicular direction. The cutter is designed to cut 6 parallel equidistant grooves simultaneously. The cuts were deep enough to reach the substrate, i.e. the insert was cut through its entire thickness all the way to the material of the injected body. The cuts were about 5 mm from the insert's edges. The lattice was lightly brushed off using a soft brush running across the lattice in both diagonal directions. The self-adhesive tape was applied at the centre of the lattice parallel with one of the cuts. By holding the tape by its loose end it was lifted up at the rate of 0.5 to 1.0 s and at an angle of approx. 60°. Then the result was assessed immediately after removing the tape in accordance with the classification of the test results, describing a degree of the lattice disruption or damage:
0—the cuts are completely smooth; no lattice square is damaged.
1—a minor damage at the locations of cut crossings; the damaged area is less than 5% of its overall area.
2—the paint/foil shows minor damage along the cuts and at their crossings; the damaged area is between 5% and 15% of its overall area.
3—partial damage at the corners of the cuts, partial damage along the cuts, partial or total damage at various places of the lattice; the damaged area of the lattice is between 15% and 35% of its overall area.
4—large changes in the cut corners, some lattice squares are partially or completely damaged; the lattice area is damaged at more than 35% and less than 65% of its overall area.
5—changes are larger than at degree 4.

### Pull-Off Adhesion Test

This test according to the ČSN/ISO EN 4624 standard defines a pull-off test on coating(s) of paint or similar products. The test result is the minimum tensile stress needed to detach or rupture the weakest interface of the tested arrangement of paint layers or similar layer arrangement. The minimum values of the tensile stress (i.e. adhesion) for paint layers should be at least 3 MPa.

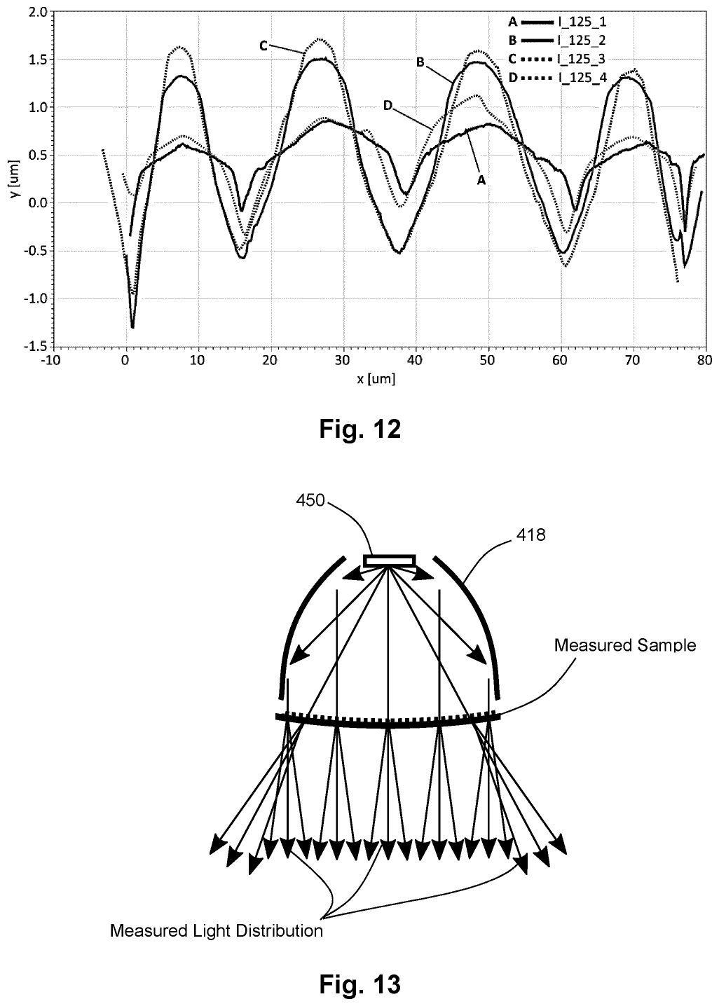

The pull-off test was performed using an ELCOMETER F106 tool set (testing range 0-22 MPa), a standardized aluminium cylinder (i.e. dolly), cutting tool, and an adhesive—namely ARALDITE 2-part epoxy. A sample test arrangement 300 is illustrated in FIG. 10. The following steps were performed:
Gentle fine grit sanding of the cylinder/dolly 313 and surface of the injected insert 302;
Mixing ARALDITE epoxy using 1:1 resin to hardener ratio;
Application of the adhesive 317 to a functional surface of the cylinder/dolly 313 and attaching it to the surface of the injected insert 302's surface;
Hardening (for 24 hours);
Cutting (as shown in FIG. 10), to form cuts 315, through the entire thickness of the injected insert 302 (i.e. down into the injection moulded body 318) around the periphery of the cylinder/dolly 313;
Securing the cylinder/dolly 313 into an outer ring (i.e. sleeve) and attaching it to the testing apparatus;
Performing the pull-off operation;
Determining the value of the tensile stress (in MPa from the instrument readout).

### Assessment of the Break (Bond Failure)

The assessment of the bond failure was determined as a percentage of the area of the cylinder/dolly associated with an area of the breakage at the respective layer in the test arrangement, according to the following Table 1, in which A=injection moulded body, B=injected insert, C=epoxy:

TABLE 1
Table of positions and types of bond
failures in the test arrangement

| Position | Type of Bond Failure |
|---|---|
| A | Cohesive failure (breakage) of substrate (injection |
| | moulded body) |
| A/B | Bond (adhesion) failure between the substrate and first |
| | layer (insert) |
| B | Cohesive failure of the insert |
| B1 | Bond failure between first and second layer (if applicable) |
| . . . | (evaluation of other “B” layers if present) |
| Bx/C | Bond failure between last layer and the adhesive (epoxy) |
| C | Cohesive failure of the adhesive (epoxy) |
| C/D | Bond failure between the adhesive (epoxy) and dolly |

(A = injection moulded body, B = injected insert, C = epoxy)

### Environmental Testing

Apart from adhesion testing, the product described in this example had to withstand also environmental testing according to standard ISO EN 60079-0:2012+A11:2013 Explosive atmospheres—Part 0: Equipment—General requirements. The test was performed in a climatic test chamber CTS C-40/1500 to verify the resistance of the tested product to elevated and freezing temperatures. The testing was carried out in a sequence dictated by the standard. The resistance to heat was tested at 90% humidity and at temperature 90° C. for a period of 672 hours. The resistance to freezing temperatures was tested at temperature −30° C. for a period of 24 hours.

### Photometric Measurements

The product has to withstand environmental testing not only from the structural resistance standpoint (i.e. so that there is no cracking or bond separation between the injected insert and the injection moulded body), but also from the optical performance standpoint. Therefore, the product underwent photometric testing before and after the environmental testing. Photometric tests (such as, for example, measurement of luminosity) were done according to standards ISO EN 13032-1 and EN 13032-4+A1. The result was the comparison of the optical performance before and after environmental testing in the climatic chamber.

### Measurements of Deformation of the Profile

The photometric measurements are the ultimate test of the successful transfer of the pre-produced micro- or nano-relief structure onto the injection moulded body, in accordance with the essence of the present invention. If the relief is not damaged or compromised, then neither will be the optical function. The direct measurements of the relief profile (for example by AFM), may, however, provide much useful information about the process of injecting an in-mould insert with the component/part's body. The analysis of the results may then provide guidance as to how to modify the injection moulding process parameters in order to avoid or minimise deformations of the relief profile. Set out below is an example of the profile measurements performed on multiple samples in an effort to determine optimum conditions for the successful transfer of the relief profile to the injection moulded body of the produced component/part, i.e. in this case the transparent cover of the LED luminaire.

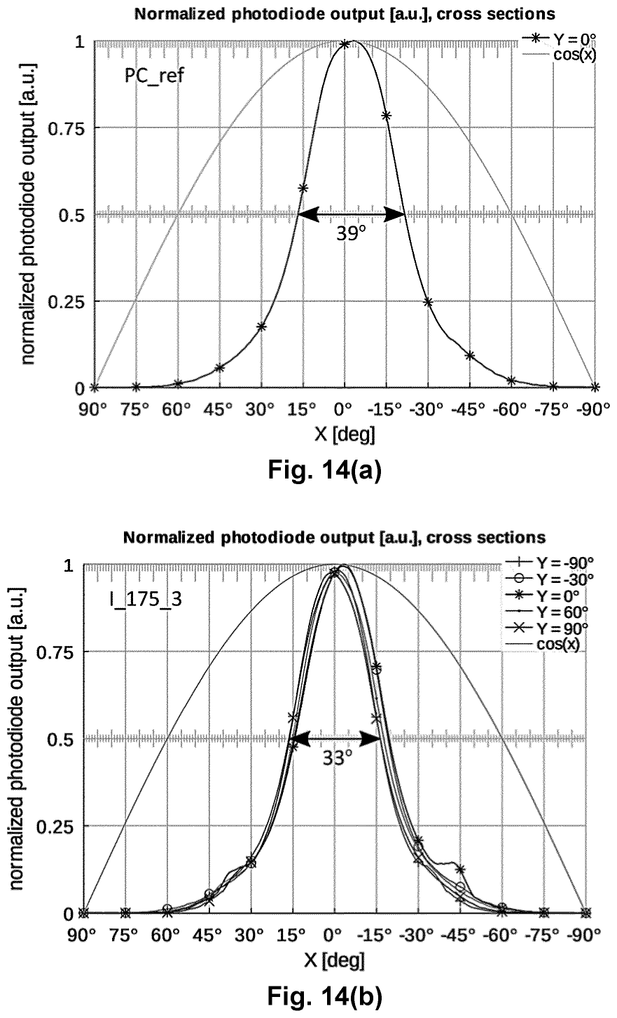

The measurements started with the relief profile of a pre-produced foil insert 125 micrometres thick. The foil insert had a nano-relief structure with relief average height approx. 1.4 micrometres and a maximum height about 2.8 micrometres. The typical lateral dimensions of the relief features were approximately in a range from about 10 to about 25 micrometres—see the cross-sectional profile shown in FIG. 11(a). The relief structure was embossed directly into the base material of the foil using a thermo-embossing process.

Before injecting, a reference measurement of the relief profile using AFM (Digital Instruments Dimension 3100) was made on the insert alone, the result of which is shown in FIG. 11(a), which shows the reference profile of a portion of the cross-section of the nano-relief of the representative stand-alone foil insert sample.

Then, multiple insert samples were then rear-injected onto the body of the luminaire's cover under different conditions (i.e. with different processing parameters). After injecting, the measurements of the relief profile of these samples were measured and the results are summarised in Table 2 below. Note that in the below Table 2 the location descriptions are as follows:
Location 1—on the centre-line of the injection moulded part against the injecting gate,
Location 2—on the centre-line half-way between two adjacent injecting gates,
Location 3—as Location 2 but offset towards the edge of the injection moulded part at the edge of the part against the injecting gate with offset (i.e. farthest distance from the injecting gate),
Location 4—as Location 1 but offset towards the edge of the part.

TABLE 2
Summary of the results of measurements of the profile height loss on
a relief structure formed directly in the base material of the foil
insert for different processing parameters, foil thicknesses and locations
on the final injection moulded part (optical luminaire cover).

| Processing Parameters | I | | II | |
|---|---|---|---|---|
| Mould temperature | 60° | C. | 80° | C. |
| Melt temperature | 290° | C. | 310° | C. |
| Injection time | 2 | s | 1.7 | s |
| Injection pressure | 215 | bar | 190 | bar |
| | | | 202 | bar* |

| | Location of The | Loss of Profile | |
|---|---|---|---|
| Foil | Measured | Height | |
| Thickness | Structure | (%) | |
| 125 | 1 | 66 | 74 |
| | 4 | 56 | — |
| | 2 | 23 | 62 |
| | 3 | 20 | — |
| *175 | 1 | 75 | 79 |
| | 2 | 52 | — |
| | 3 | 11 | 69 |
| | 4 | 4 | 41 |
| *250 | 1 | 82 | 71 |
| | 2 | 74 | — |
| | 3 | 9 | 68 |
| | 4 | 4 | 57 |

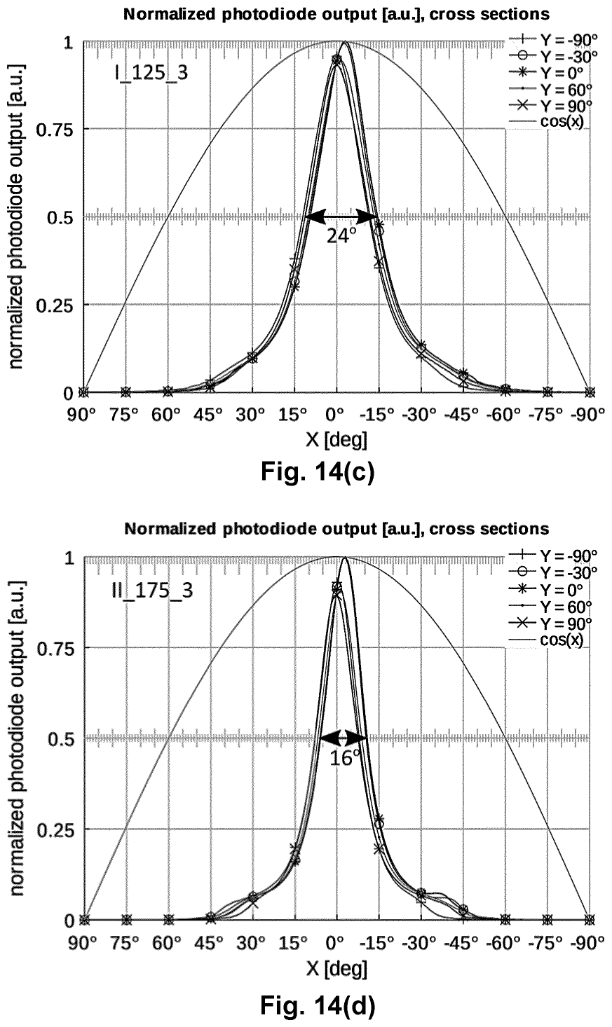

As the results in the above Table 2 show, the overall less degradation of the relief profile on the injected insert was achieved with the I settings of the processing parameters—as shown by the profile measurements in FIG. 12 (which graph shows the degradation of the profile under the I conditions, with a foil thickness of 125 μm and measured at locations 1 to 4)—and with the use of a thicker foil insert. However, the degradation (i.e. loss of profile height) was highly dependent on the distance from the injecting gate.

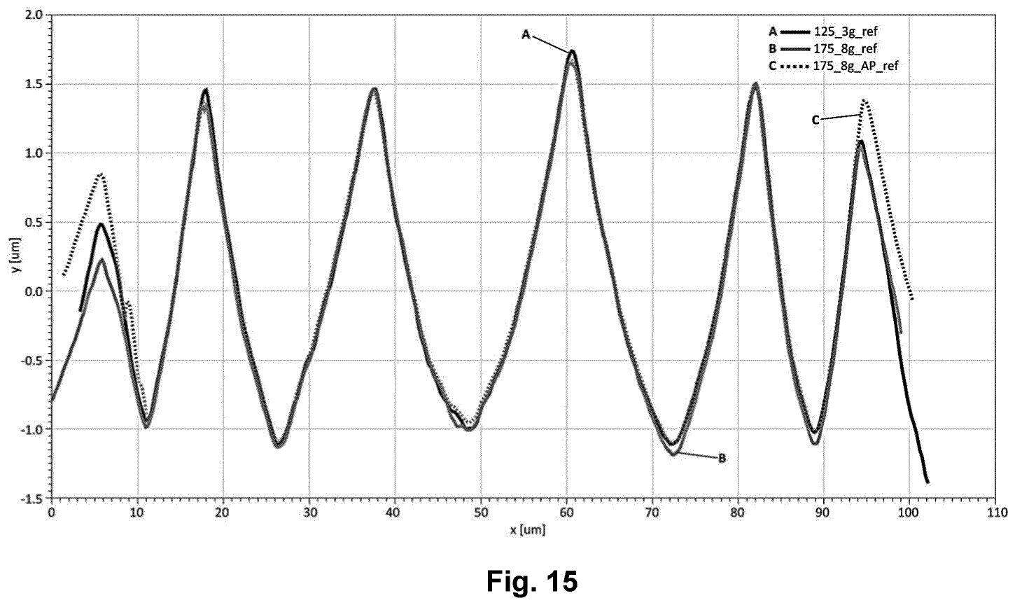

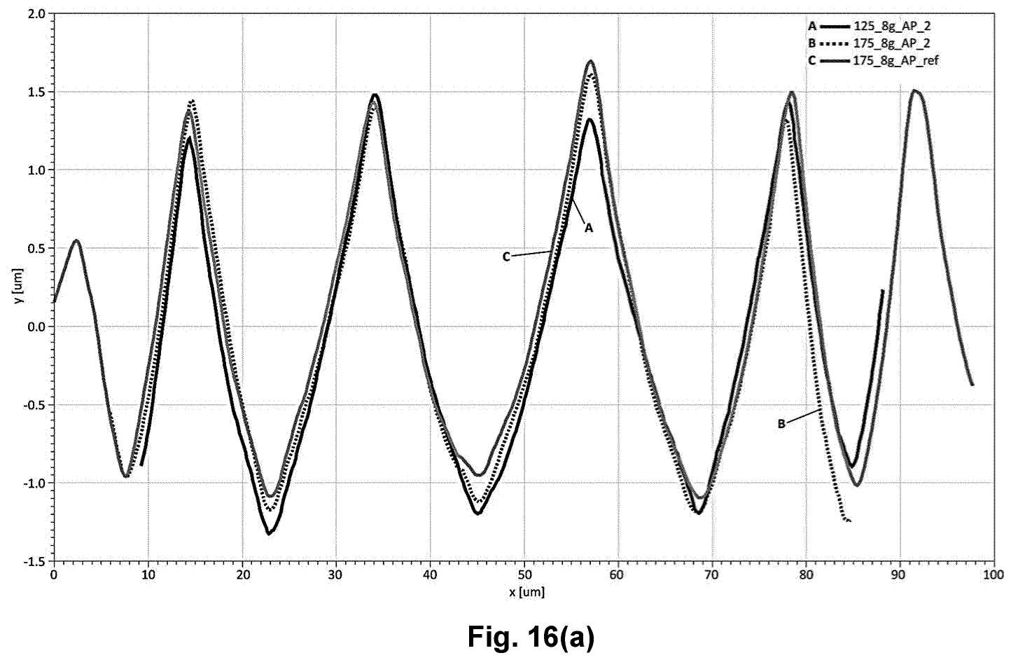

Not only was the degradation of the profile itself measured, but also the effect of the degradation on the optical function was measured. The optical function of the reference (i.e. stand-alone insert) structure was compared with the rear-injection moulded structure on a variety of selected samples—see the light distribution curves on the graphs of FIGS. 14(a)-14(d). The samples were illuminated with a pre-collimated light beam, with an LED as a light source, a reflector (with its output aperture around 10 mm) as the collimating element with the measured insert located at the output of the reflector, as shown in the arrangement of FIG. 13. The optical function of the insert, i.e. the angular distribution of the intensity, was measured using a photodiode based detector at the distance of approx. 1 m. The reference structure spread a beam into a ˜40° cone, as illustrated by the reference light intensity distribution curve shown in FIG. 14(a). Structures with different degrees of degradation showed less ability to spread the pre-collimated beam. Only the least degraded sample I_175_3 (with a height reduction of about 4%) showed a close match with the reference curve. (Note: in the illumination industry a +/−5° deviation from a nominal or reference distribution is usually acceptable, and can be considered as a close match.) These light intensity distribution results for the various samples are shown in the graphs of FIGS. 14(a)-14(d).

The results of these experiments indicated that, for a given range of foil insert thicknesses and processing parameters ensuring a sufficiently strong and durable bond, the deformation of the relief may not always be maintained at an acceptable level (i.e. with a profile height loss of no more than approx. ˜5%) across the entire structured area of the insert.

Although these experiments indicated that increasing the thickness of the foil insert may lead to a reduction of the degradation of the relief during the injection moulding cycle (i.e. resulting in a reduction of the amount of heat transferred from the molten material to the relief), it was not practical to use a thicker foil beyond 250 micrometres, since it would be difficult to keep it bent into the required form in the mould by a vacuum and it would reduce the clearance in the mould's cavity for achieving a good flow of molten material during the injection moulding cycle.

Therefore, in this case, a different approach to the problem of connecting the structured insert to the injection moulded body without unacceptable profile deformation was tried. This led to an idea to use an insert with the same base material as described above, i.e. PC (and with the same thicknesses), but with the nano-relief formed in a material with a higher glass transition temperature than the base material of the insert. Also, it was preferred that, before use in the injection moulding cycle, the production process of the insert included a step of post-baking a UV polymer on the insert substrate with the temperature profile peaking at or near the glass transition temperature of the insert for a duration of the injection moulding cycle (i.e. at least for about 2 s). This should ensure that the degradation of the insert's profile structure due to elevated temperature during the injection moulding cycle would be minimised.

Thus, the following procedure was followed: Polycarbonate foil inserts of 125 and 175 micrometre thicknesses were produced, with a nano-structured relief formed by a standard nano-imprint technique in a UV photopolymer layer attached to the foil. The key feature of such inserts was to use a UV photopolymer with a significantly higher glass transition temperature (or alternatively melting temperature if a glass transition temperature is not definable for the material in question, or alternatively still temperature of onset of thermal decomposition if neither a glass transition temperature nor a melting temperature are definable for the material in question, as appropriate—see above) than that of the base polycarbonate foil. This change may be important in the practising of certain embodiments of the present invention.

The cured UV photopolymer used was of an acrylate type, and whilst it did not have a glass transition temperature or melting temperature as such it did have a temperature of onset of thermal decomposition of >20% higher than the glass transition temperature of the polycarbonate foil, which was approx. 150° C. The insert was produced in several versions, namely:
on 125 and 175 micrometre thick foils,
with UV layer densities of 3 and 8 g/m²,
with and without an adhesion promoter layer between the polycarbonate base foil and UV photopolymer.

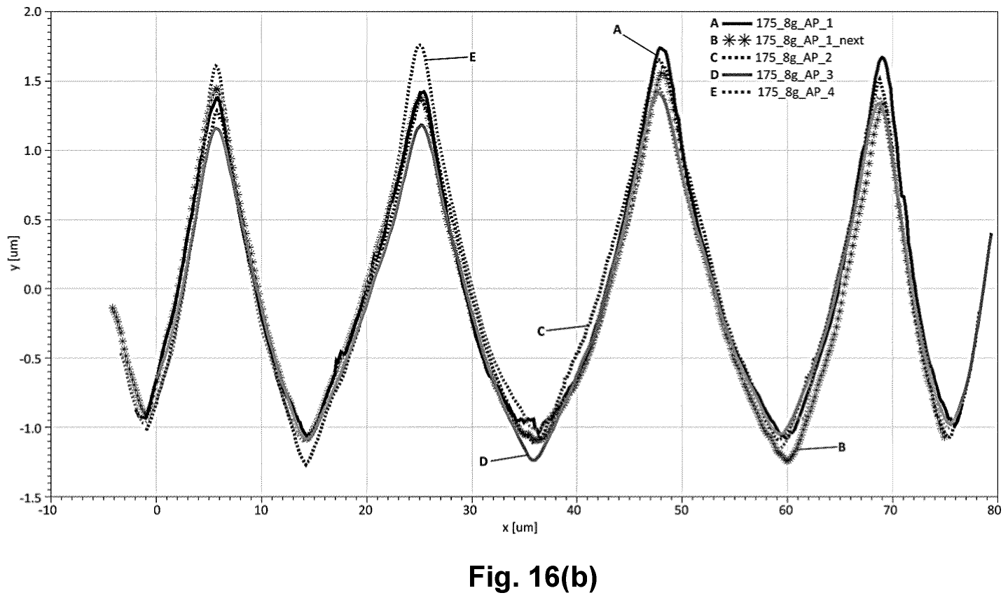

Again, and as above, the reference profile shapes for the various insert versions were measured on stand-alone inserts on AFM (Digital Instruments Dimension 3100), as shown by the graph of FIG. 15. As can be seen from these results, they all exhibited practically identical profile shapes.

The injection moulding parameters were set as follows:
Mould temperature: 80° C.
Melt temperature: 305° C.
Injection time: 1.4 s
Injection pressure: 140 bar.

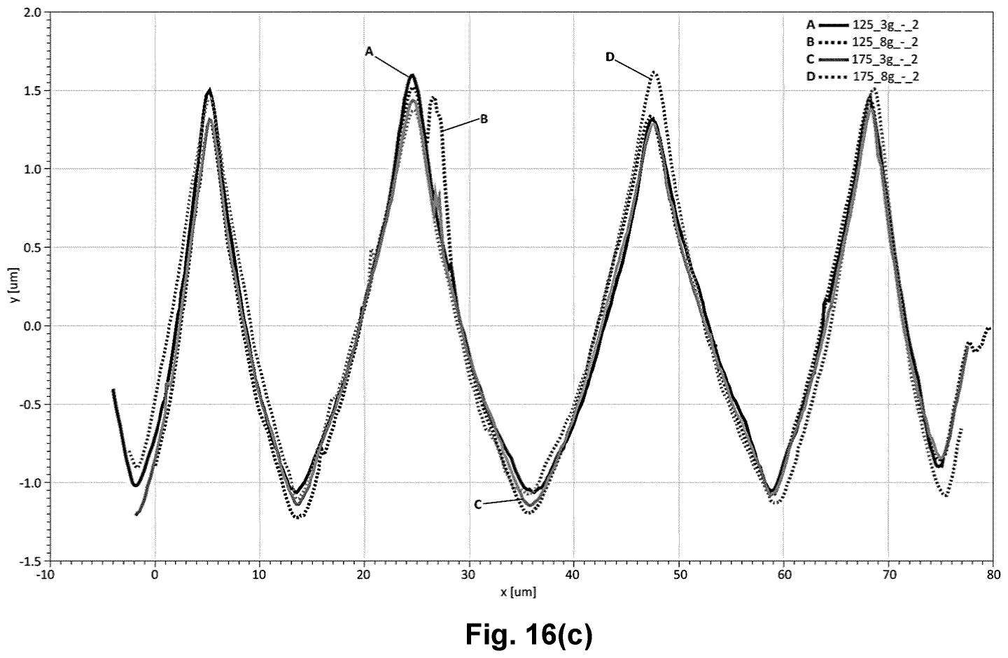

After the injection moulding the profiles of the various samples were measured first at location 2 of the injected parts (i.e. halfway between two neighbouring injection gates). The results of these profile measurements are illustrated in FIG. 16(a), which show that the loss of the height of the profile was minimal for all samples (in general slight differences in the profiles may be attributed to various factors, such as limited measurement accuracy and slightly different (i.e. not completely corresponding) locations on the measured structure).

Additional measurements were carried out on the injected inserts of 175 micrometres thickness at locations 1 to 4—which results are shown in FIG. 16(b).

All these measurements confirmed that the use of an in-mould insert with a micro- or nano-structure formed in a layer of a higher glass transition temperature (or alternatively melting temperature if a glass transition temperature is not definable for the material in question, or alternatively still temperature of onset of thermal decomposition if neither a glass transition temperature nor a melting temperature are definable for the material in question, as appropriate—see above) than that of the insert's base/substrate is a good solution for making products according to certain embodiments of the present invention.

More generally, however, the injection moulding process of many embodiments of the present invention, for producing a plastic part with an optical function based on a surface relief micro- or nano-structure carried by an in-mould insert injected to the body of the plastic part, may be pre-designed as a standard injection moulding process for injecting a plastic foil or a thin sheet or plate to a plastic body using industry standards, guidelines and options for process tuning as may be known in principle from the existing art. However, this invention offers a new solution to limitations and shortcomings of the known technology in this context, which relate to how to maintain and preserve the height and shape of the relief structure carried by the foil insert during the injection moulding cycle. This is achieved by carefully selecting, and if or as necessary modifying, the injection moulding process parameters based on calculations of heat transfer from the molten material to the relief layer, which ensures that a temperature below the glass transition temperature (or alternatively the melting temperature if a glass transition temperature is not definable for the material in question, or alternatively still the temperature of onset of thermal decomposition if neither a glass transition temperature nor a melting temperature are definable for the material in question, as appropriate—see above) of at least the relief layer, and/or using an insert with a relief layer made from a material with a glass transition temperature (or alternatively melting temperature if a glass transition temperature is not definable for the material in question, or alternatively still temperature of onset of thermal decomposition if neither a glass transition temperature nor a melting temperature are definable for the material in question, as appropriate—see above) higher than that of the base/substrate material of the foil or sheet/plate insert by at least about 20% (or even at least about 40 or 50%), and preferably keeping the temperature parameters towards the lower side of the possible temperature ranges, is maintained during the injection moulding cycle. Furthermore, this careful control of the injection moulding process parameters allows optimisation of the strength of the bond between the insert and the body of the plastic part, in particular for insert base/substrate and injected body materials combinations such as the thermoplastics PC-PC, PMMA-PMMA, SAN-SAN, MABS-MABS, and their blends, as well as others.

Throughout the description and claims of this specification, the words “comprise” and “contain” and linguistic variations of those words, for example “comprising” and “comprises”, mean “including but not limited to”, and are not intended to (and do not) exclude other moieties, additives, components, elements, integers or steps.

Throughout the description and claims of this specification, the singular encompasses the plural unless expressly stated otherwise or the context otherwise requires. In particular, where the indefinite article is used, the specification is to be understood as contemplating plurality as well as singularity, unless expressly stated otherwise or the context requires otherwise.

Throughout the description and claims of this specification, features, components, elements, integers, characteristics, properties, compounds, chemical moieties or groups described in conjunction with a particular aspect, embodiment or example of the invention are to be understood to be applicable to any other aspect, embodiment or example described herein unless incompatible therewith or expressly stated otherwise.

Furthermore, it is expressly envisaged in this disclosure of the present invention that the various aspects, embodiments, examples, features and alternatives, and in particular the individual constructional, configurational or operational features thereof, set out in the preceding paragraphs, in the claims and/or in the following description and accompanying drawings, may be taken independently or in any combination of any number of same. For example, individual features described in connection with one particular embodiment, or described singly or in combination with another feature in any one or more embodiments, are applicable on their own or in combination with one or more other features to all embodiments and may be found and used in combination with any other feature in any given embodiment, unless expressly stated otherwise or such features are incompatible.

1. A method for injection moulding an optical component with an incorporated optical function, the component comprising an injection moulded body and at least one optically functional relief structure applied thereto, the relief structure forming or contributing to the optical function of the component to be moulded, wherein the method comprises:
(i) providing an insert comprising the said optical structure in the form of an open-face relief structure provided on a face, surface or portion of the insert,
(ii) mounting the insert inside a mould cavity in which the component is to be moulded, with the open-face relief structure facing and at least partially abutting a surface portion of the mould cavity, and
(iii) rear-injection moulding a body of the component within the mould cavity so as to incorporate the insert in the component body,
wherein the said method is carried out with parameters selected and/or controlled such that during the injection moulding step (iii) the temperature at or on the face, surface or portion of the insert provided with the relief structure remains below the lowest of the glass transition temperature, melting temperature and temperature of onset of thermal decomposition of the material of that face, surface or portion of the insert.

2. A method according to claim 1, wherein the parameter(s) of the injection moulding method, which are selected and/or controlled to achieve the defined temperature limitation on the temperature experienced at or on the face, surface or portion of the insert provided with the relief structure, are additionally selected and/or controlled such that, during the injection moulding step (iii) of the method, an integral bond is formed or created between the insert and the injection moulded body of the component.

3. A method according to claim 1, wherein the insert takes the form of a foil, sheet, film, web or plate of a plastics or polymer material.

4. A method according to claim 1, wherein the body of the injection moulded optical component is of, or comprises, a material, optionally a plastics or polymer material, which is compatible with the material of the insert (or the material of a substrate or base layer of the insert, where such a substrate or base layer is present as a discrete layer of the insert) on one or more sides of the insert which come(s) into contact with molten material of the moulded optical component during the injection moulding method.

5. A method according to claim 4, wherein the said compatibility is at least chemical compatibility, such that the polymer of the component body and the insert (or the substrate or base layer thereof, as the case may be) are selected to be either (i) the same polymer material, or (ii) different varieties (optionally different by molecular weight or chemical substituent(s)) of the same chemical species of polymer, or (iii) of the same chemical class or group of polymers.

6. A method according to claim 1, wherein the relief structure comprises optically functional relief with a relief feature average height in a range of less than, or no more than, about 50 micrometres, optionally in a range of from about 0.25 to about 50 micrometres, further optionally from about 0.5 to about 20 micrometres, even further optionally from about 1 to about 10 micrometres.

7. A method according to claim 1, wherein the maximum height of the relief features does not exceed about 100 micrometres, and optionally is below about 50 or 20 or 10 micrometres.

8. A method according to claim 1, wherein the lateral (or sideways) sizes or widths of the structural features of the relief structure are in a range of from about 20 or 30 or 40 or 50 nm up to about 200 or 300 or 400 or 500 micrometres, optionally from about 500 nm up to about 200 micrometres, such size measurements being defined and measured in at least in one lateral (or sideways) direction across at least a portion of the relief structure transversely to the general direction of orientation or alignment of the relief features thereof (or of the relief features in that portion of the structure).

9. A method according to claim 1, wherein the mounting of the insert inside the mould cavity is effected or carried out by means of mounting or attachment means, wherein such mounting or attachment means comprise one or more of any of the following: electrostatic mounting/attachment means, vacuum-operated mounting/attachment means, mechanical mounting/attachment means, or any combination of any of the aforesaid.

10. A method according to claim 1, wherein the mounting of the insert inside the mould cavity, with the open-face relief structure facing and at least partially abutting a surface portion of the mould cavity, is such that at least one or more portions of the open-face relief structure face and are at least partially in direct contact with one or more surface portions of the mould cavity.

11. A method according to claim 1, wherein the insert comprises a base or substrate of the material from which the insert is formed, with the optical relief formed directly in or on a surface of the base or substrate material of the insert.

12. A method according to claim 1, wherein the optical relief is formed in or on a surface of a discrete or distinct layer which is attached to a base or substrate material of the insert.

13. A method according to claim 12, wherein the discrete/distinct layer in which the optical relief is formed and the base/substrate layer of the insert are each independently of a or a respective polymeric material, and the polymers of the base/substrate and of the discrete/distinct layer are (i) the same or different polymers, or (ii) polymers of the same or different chemical classes or groups.

14. A method according to claim 12, wherein the discrete/distinct layer in/on which the optical relief is formed and the base/substrate layer of the insert are each independently of a or a respective polymeric material, and the polymers of the base/substrate and of the discrete/distinct layer are selected such that the respective lowest of the glass transition temperature, melting temperature and temperature of onset of thermal decomposition of each of those two polymers are substantially or approximately the same.

15. A method according to claim 12, wherein the discrete/distinct layer in/on which the optical relief is formed and the base/substrate layer of the insert are each independently of a or a respective polymeric material, and the polymers of the base/substrate and of the discrete/distinct layer are selected such that the lowest of the glass transition temperature, melting temperature and temperature of onset of thermal decomposition of the polymer of the discrete/distinct layer (in/on which the optical relief is formed) is higher than the lowest of the glass transition temperature, melting temperature and temperature of onset of thermal decomposition of the polymer of the base/substrate layer of the insert.

16. A method according to claim 15, wherein the polymers of the base/substrate and of the discrete/distinct layer are selected such that the lowest of the glass transition temperature, melting temperature and temperature of onset of thermal decomposition of the polymer of the discrete/distinct layer (in/on which the optical relief is formed) is at least about 20% (or optionally at least about 40 or 50%) higher than the lowest of the glass transition temperature, melting temperature and temperature of onset of thermal decomposition of the polymer of the base/substrate layer of the insert.

17. A method according to claim 1, wherein the insert has been subjected to a pre-baking or other pre-heat-treatment step at a temperature up to at least about 0.5 or 1 or 2 or 3 or 4 or 5 or 6 or 7 or 8 or 9 or 10 or 15 or 20 or 25 or 30° C. below the glass transition temperature (or alternatively the melting temperature if a glass transition temperature is not definable for the material in question, or alternatively still the temperature of onset of thermal decomposition if neither a glass transition temperature nor a melting temperature are definable for the material in question) of the material of the body or substrate layer of the insert, whereby the said pre-baking or other pre-heat-treatment step is sufficient to ensure that the relief structure layer substantially does not undergo any significant structural changes which negatively or deleteriously affect the optical function of the relief structure when the temperature of the insert or of its substrate/base and/or relief structure layer(s) is elevated to a temperature near or approaching the lowest of the glass transition temperature, melting temperature and temperature of onset of thermal decomposition of the material of the body or substrate layer of the insert during the ensuing injection moulding process.

18. An apparatus for injection moulding an optical component with an incorporated optical function, the component comprising an injection moulded body and at least one optically functional relief structure applied thereto, the relief structure forming or contributing to the optical function of the component to be moulded, wherein the apparatus comprises:
(i) a mould including a cavity in which the component is to be moulded;
(ii) means for mounting inside the mould cavity an insert comprising the said optical structure in the form of an open-face relief structure provided on a face, surface or portion thereof, the insert being mountable in the mould cavity with the open-face relief structure facing and at least partially abutting a surface portion of the mould cavity; and
(iii) means for rear-injection moulding a body of the component within the mould cavity so as to incorporate the insert in the component body,
wherein the apparatus comprises means for selecting and/or controlling parameters of the injection moulding such that during the rear-injection moulding of the component body within the mould cavity the temperature at or on the face, surface or portion of the insert provided with the relief structure remains below the lowest of the glass transition temperature, melting temperature and temperature of onset of thermal decomposition of the material of that face, surface or portion of the insert.

19. An injection moulded optical component with an incorporated optical function, the component comprising an injection moulded body and at least one optically functional relief structure applied thereto, the relief structure forming or contributing to the optical function of the component to be moulded, wherein the optical component is produced by a method according to claim 1.

20. (canceled)

21. An optical device, especially a luminaire or vehicle lamp, comprising at least one injection moulded optical component, optionally being a cover therefor, according to claim 19.

22. An injection moulded optical component with an incorporated optical function, the component comprising an injection moulded body and at least one optically functional relief structure applied thereto, the relief structure forming or contributing to the optical function of the component to be moulded, wherein the optical component is produced using an apparatus according to claim 18.

23. An optical device, especially a luminaire or vehicle lamp, comprising at least one injection moulded optical component, optionally being a cover therefor, according to claim 22.
